(19) United States
(12) Patent Application Publication
(10) Pub. No.: US 2025/0068928 A1
(43) Pub. Date: Feb. 27, 2025

(54) Decentralized Federated Learning Systems, Devices, and Methods for Security Threat Detection and Reaction

(71) Applicant: Alarm Tek Smart Security Inc., Saskatoon (CA)

(72) Inventors: Corridon Watt Mckelvey, Saskatoon (CA); Jeffrey Barnhardt, Saskatoon (CA); Joshua Lewis, Saskatoon (CA); Oleksandr Gandzha, Saskatoon (CA)

(21) Appl. No.: 18/715,184

(22) PCT Filed: May 8, 2023
(86) PCT No.: PCT/CA2023/050623

§ 371 Date: May 31, 2024

Related U.S. Application Data
(60) Provisional application No. 63/339,724, filed on May 9, 2022.

(51) Int. Cl. G06N 3/098; G08B 13/196; G08B 31/00; H04L 9/00

(52) U.S. Cl. CPC G06N 3/098; G08B 13/196; G08B 31/00; H04L 9/50

(57) ABSTRACT

There are described various embodiments for devices, systems, and methods for security threat detection and reaction using multi-layered decentralized federated learning approach, for use in various combinations of security systems, including facial recognition systems, biometric recognition systems, gesture recognition systems, voice recognition systems, network traffic pattern monitoring systems, security systems using Internet of Things (IoT) sensors, and home automation security systems. By combining federated learning system with a local interpretation layer, it is possible for each local node in a system to interpret anonymized federated learning results into highly personalized results, which can then be used to trigger highly personalized actions. The multi-layered federated learning threat detection and response system therefore optimizes for both enhanced privacy and customization.

### CROSS-REFERENCE TO PREVIOUS APPLICATION

This application claims priority from U.S. provisional patent application No. 63/339,724 filed on May 9, 2022, which is incorporated herein by reference in its entirety.

### FIELD

Various embodiments are described herein that generally relate to systems, devices, and methods for decentralized federated learning-based security threat detection and reaction.

### INTRODUCTION

The following paragraphs are provided by way of background to the present disclosure. They are not, however, an admission that anything discussed therein is prior art or part of the knowledge of persons skilled in the art.

Various security systems exist for protecting individuals' personal security and digital privacy. Some advanced smart security systems can use facial recognition, using data from home security cameras or smart doorbells. In conventional smart security systems, however, data is typically sent to remote servers for analysis, creating data privacy concerns. In federated learning systems, system nodes are trained with local samples and exchange machine learning parameters with other nodes in the system or with a central server to reduce or eliminate the need for local data to be sent externally. However, current systems can be unreliable and ill-equipped to respond to security threats. Blockchain technology is sometimes integrated within federated learning systems to improve reliability and trustworthiness. For example, federated learning with blockchain has been used for vehicular communication networking. However, current systems can be slow and have high memory requirements.

There is a need for systems, devices and methods for security threat detection and reaction that address the challenges and/or shortcomings described above.

### SUMMARY

Various embodiments of a system, device and method for decentralized federated learning-based security threat detection and reaction, and computer products for use therewith, are provided according to the teachings herein.

According to one aspect of the present disclosure, there is provided a device of a plurality of devices in a decentralized federated learning security system. The device comprises one or more local AI models each configured to receive inputs from the one or more sensors and to be trained to make a prediction relating to events of an event type being sensed by the one or more sensors. The device also comprises one or more associated global AI models each configured to receive inputs from the one or more sensors and to make a prediction relating to events of an event type being sensed by the one or more sensors, wherein each of the one or more global AI models relating to a given event type is comprised of an aggregation of local AI models from the plurality of devices relating to the given event type. The device also comprises one or more processors. The one or more processors are configured to train a local AI model relating to an associated global AI model using new inputs received from the one or more sensors when inputting the new input into the associated global AI model fails to result in a prediction having threshold characteristics, thereby creating a newly trained local AI model, and send the newly trained local AI model to other devices of the plurality of devices. The device also comprises a memory containing newly trained local AI models of the plurality of devices.

In some examples, the one or more processors are further configured to receive a newly trained local AI model associated with a particular event type from another device of the plurality of devices. The one or more processors are also further configured to validate the received newly trained local AI model by: selecting a plurality of the most recent local AI models associated with the particular event type from the memory, aggregating the selected local AI models and the received newly trained AI model into an aggregated AI model, detecting anomalies in the aggregated AI model, and sending a validation signal associated to the newly trained AI model to a set of devices of the plurality of devices if no anomaly is detected.

In some examples, the one or more processors are further configured to, upon receipt of a validation signal from a device of the plurality of devices: store a newly trained model associated with the validation signal to the memory, select a plurality of the most recent local AI models associated with the particular event type from the memory, and aggregate the selected local AI models and the received newly trained AI model into a new global AI model.

In some examples, the step of aggregating the selected local AI models includes summing the local AI models.

In some examples, validation of the newly trained model is further performed using a consensus mechanism.

In some examples, the consensus mechanism is a proof-of-stake consensus mechanism.

In some examples, the device further comprises a local interpretation module configured to interpret predictions made by the global machine learning model using local information relevant to the user of the edge device in order to produce a threat assessment.

In some examples, the threat assessment comprises a determination of one of three or more threat levels.

In some examples, the determination of the one of three or more threat levels is based at least in part on the threshold characteristics.

In some examples, the threat assessment is used to perform an action by the system.

In some examples, the action is one of: notifying a user and/or owner of the system, notifying the police, doing nothing, and sounding an alarm.

In some examples, the device comprises one or more of the one or more sensors.

In some examples, the threshold characteristics include a confidence level related to the prediction.

In some examples, the one or more sensors includes a video camera, and the event type is associated with the detection of an optical or auditory characteristic of the video feed.

In some examples, the detection of an optical or auditory characteristic includes facial recognition.

In some examples, the one or more sensors includes a packet analyzer, and the event type is associated with packet features.

In some examples, the packet features include one or more of packet source address, packet destination addresses, type of service, total length, protocol, checksum, and data/payload.

In some examples, the one or more sensors is an Internet of Things (IoT) sensor, and the event type is associated with signals received from the IoT sensor.

In some examples, the memory comprises a blockchain containing newly trained local AI models of the plurality of devices.

In some examples, each block in the blockchain comprising a newly trained local machine learning model of a given device contains a pointer to the immediately preceding version of the newly trained machine learning model of the given device.

According to another aspect of the present disclosure, there is provided a method of operating a device of a plurality of devices in a decentralized federated learning security system. Each device comprises one or more local AI models each configured to receive inputs from the one or more sensors and to be trained to make a prediction relating to events of an event type being sensed by the one or more sensors, and one or more associated global AI models each configured to receive inputs from the one or more sensors and to make a prediction relating to events of an event type being sensed by the one or more sensors. Each of the one or more global AI models relating to a given event type is comprised of an aggregation of local AI models from the plurality of devices relating to the given event type, and a memory containing newly trained local AI models of the plurality of devices. The method comprises training a local AI model relating to an associated global AI model using new inputs received from the one or more sensors when inputting the new input into the associated global AI model fails to result in a prediction having threshold characteristics, thereby creating a newly trained local AI model. The method also comprises sending the newly trained local AI model to other devices of the plurality of devices.

In some examples, the method further comprises receiving a newly trained local AI model associated with a particular event type from another device of the plurality of devices. The method also comprises validating the received newly trained local AI model by: selecting a plurality of the most recent local AI models associated with the particular event type from the memory, aggregating the selected local AI models and the received newly trained AI model into an aggregated AI model, detecting anomalies in the aggregated AI model, and sending a validation signal associated to the newly trained AI model to a set of devices of the plurality of devices if no anomaly is detected.

In some examples, upon receipt of a validation signal from a device of the plurality of devices: storing a newly trained model associated with the validation signal on the memory, selecting a plurality of the most recent local AI models associated with the particular event type from the memory, and aggregating the selected local AI models and the received newly trained AI model into a new global AI model.

In some examples, aggregating the selected local AI models includes summing the local AI models.

In some examples, validation of the newly trained model is further performed using a consensus mechanism.

In some examples, the consensus mechanism is a proof-of-stake consensus mechanism.

In some examples, the method further comprises interpreting predictions made by the global machine learning model using local information relevant to the user of the edge device in order to produce a threat assessment.

In some examples, the threat assessment comprises a determination of one of three or more threat levels.

In some examples, the determination of the one of three or more threat levels is based at least in part on the threshold characteristics.

In some examples, the threat assessment is used to perform an action by the system.

In some examples, the action is one of: notifying a user and/or owner of the system, notifying the police, doing nothing, and sounding an alarm.

In some examples, the threshold characteristics include a confidence level related to the prediction.

In some examples, the one or more sensors includes a video camera, and the event type is associated with the detection of an optical or auditory characteristic of the video feed.

In some examples, the detection of an optical or auditory characteristic includes facial recognition.

In some examples, the one or more sensors includes a packet analyzer, and the event type is associated with packet features.

In some examples, the packet features include one or more of packet source address, packet destination addresses, type of service, total length, protocol, checksum, and data/payload.

In some examples, the one or more sensors is an Internet of Things (IoT) sensor, and the event type is associated with signals received from the IoT sensor.

In some examples, the memory comprises a blockchain containing newly trained local AI models of the plurality of devices.

In some examples, each block in the blockchain comprising a newly trained local machine learning model of a given device contains a pointer to the immediately preceding version of the newly trained machine learning model of the given device.

According to yet another aspect of the present disclosure, there is provided a decentralized federated learning security system comprising a plurality of devices as described above.

According to yet another aspect of the present disclosure, there is provided a decentralized federated learning security system comprising a plurality of devices configured to perform a method as described above.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein. In the drawings:

FIG. 1 shows a block diagram of an example embodiment of a decentralized federated learning security system;

FIG. 2 shows a block diagram of an example embodiment of a device that may be used in the system of FIG. 1;

FIG. 3 shows a detailed schematic diagram of an example embodiment of a node in the system of FIG. 1;

FIG. 4 shows a schematic diagram of a process flow of an example embodiment of a method that may be used by the system of FIG. 1 to process a security threat classified as green or red;

FIG. 5 shows a schematic diagram of a process flow of an example embodiment of a method that may be used by the system of FIG. 1 to process a security threat classified as yellow;

FIGS. 6A-6E show flowcharts of an example method of processing a security threat using facial detection that may be used by the system of FIGS. 1-3;

FIGS. 7A-7E show flowcharts of an example method 700 of processing a security threat using traffic monitoring of a home network in accordance with the system of FIGS. 1-3; and

FIGS. 8A-8E show flowcharts of an example method 800 of processing a security threat using IoT sensors in accordance with the system of FIGS. 1-3.

Further aspects and features of the example embodiments described herein will appear from the following description taken together with the accompanying drawings.

### DESCRIPTION OF VARIOUS EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein. For example, while several of the embodiments described herein include the use of blockchain technology, it will be readily understood by those skilled in the art that the systems, device and methods described herein could be implemented without using blockchain technology. Blockchain is an example of one technology that can be used to increase the security of peer-to-peer systems and communications, as described herein. As such, the systems described herein may distribute and store local machine learning models and/or other information via known peer-to-peer networking systems, architectures and protocols, as described in more detail elsewhere herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” in conjunction with describing the operation of any system or method described herein is meant to be understood as describing a user interface, such as a graphical user interface (GUI), for performing initialization, configuration, or other user operations.

The example embodiments of the devices, systems, or methods described in accordance with the teachings herein are generally implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, one or more sensors, and the like depending on the implementation of the hardware.

It should also be noted that some elements that are used to implement at least part of the embodiments described herein may be implemented via software that is written in a high-level procedural language such as object-oriented programming. The program code may be written in C⁺⁺, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer useable instructions may also be in various formats, including compiled and non-compiled code.

While several of the specific embodiments described herein relate to the use of decentralized federated learning threat detection and reaction systems, devices and methods in one or more private residences, the skilled reader will readily understand that the systems, devices and methods described herein can also or instead be used in commercial locations (e.g., shopping malls, restaurants, gyms, banks, etc.), industrial locations (e.g., construction sites, mines, etc.), government locations (e.g., federal, provincial, state and municipal buildings and facilities, etc.), military locations (e.g., naval, army or air force bases and storage facilities, etc.), corporate locations (e.g., office buildings, parking garages, R&D facilities, etc.).

The term “edge device” is used herein to describe a device that provides an entry point to a federated learning system such as those described herein. Some edge devices may also be nodes, as used herein.

The term “node” is used herein to describe a device that provides processing capability to a federated learning system such as those described herein. Some nodes may also be edge devices, as used herein.

The term “sensor” is used herein to describe any component that can sense, measure, record, capture or otherwise detect and/or characterize a phenomenon in order to produce a signal, value, code, or any other form of information as an input into a federated learning system such as those described herein. Non-limiting examples of a sensor include a magnetic switch, a thermometer, a clock, a pressure sensor, a humidity sensor, a camera, a microphone, a network analyzer, a wireless analyzer.

The term “real-world event” is used herein to describe an event that happens in the physical world and that can be sensed, measured, recorded, captured or otherwise detected and/or characterized by a sensor. Non-limiting examples of real-world events include a person walking past a security camera, a noise, a door opening, and a packet being routed through a wireless or wired network.

The term “sensor event” is used herein to describe the generation of a signal, value, code, or any other form of information by a sensor, as a result of that sensor, measuring, recording, capturing or otherwise detecting and/or characterizing a real-world event.

The term “system event” is used herein to describe a result of one or more sensor events being processed by a federated learning system such as those described herein. Non-limiting examples of system events include “green events”, “yellow events” and “red events”, as described in more detail elsewhere herein. Federated learning is an Artificial Intelligence (AI) technique where local nodes are trained with local samples and exchange information, such as trained local models, between themselves to generate a global model shared by all nodes in the network. Federated learning techniques may be categorized as centralized or decentralized. In a centralized federated learning setting, the central server maintains the global model and transmits an initial global model to training nodes selected by the central server. The nodes then train the model received locally using local data and send the trained models back to the central server, which receives and aggregates the model updates to generate an updated global model. The central server can generate the updated global model without accessing data from the local nodes, as the local nodes train the global model locally and can transmit the model trained on local data without transmitting the local data. The central server then sends the updated global model back to the nodes.

In a decentralized federated learning setting, the nodes communicate with each other to obtain the global model, without a central server. In federated learning, local models typically share the same global model architecture. Datasets on which the local nodes are trained may be heterogenous. For example, a network which uses a federated learning technique may include heterogenous clients which generate and/or transmit different types of data.

In accordance with the teachings herein, there are provided various embodiments for devices, systems and methods for security threat detection and reaction using a decentralized federated learning approach, and computer products for use therewith. In accordance with the teachings herein, there are also provided various embodiments for devices, systems, and methods for security threat detection and reaction using a blockchain-based decentralized federated learning approach, and computer products for use therewith. Additionally, at least some of the embodiments described herein may be implemented using a multi-layer decentralized federated learning approach. In at least one embodiment, a local interpreting module may constitute a layer of the multi-layer decentralized federated learning system.

Federated learning can increase data privacy when compared to conventional security threat detection, which often requires data to be transmitted to a remote server for analysis, as only AI parameters or models need to be exchanged and no local data is required to be transmitted externally.

The various embodiments described herein may be used for various types of security systems, including, but not limited to, facial recognition systems, biometric recognition systems, gesture recognition systems, gait recognition systems, voice recognition systems, network traffic pattern monitoring systems on a home network, security systems using Internet of Things (IoT) sensors, and home automation security systems combining two or more of the systems listed (e.g., combining a facial recognition system and a voice recognition system).

In at least one embodiment described herein, an edge device for use in a decentralized federated learning system includes one or more sensors, one or more local AI models, one or more associated global AI models, and one or more processors configured to train a local AI model related to an associated global AI model. The one or more local AI models may be configured to receive inputs from the one or more sensors and may be trained to make a prediction relating to sensor events. The sensor events may be of a sensor event type being sensed by the one or more sensors. The associated global AI models may receive inputs from the one or more sensors and may be configured to make a prediction relating to sensor events.

In at least one embodiment, the global AI models comprise an aggregation of local AI models. Each global AI model may be associated with a given sensor event type. The one or more local AI models may be trained in response to the global model failing to return a prediction that meets predetermined criteria established by a limiting function, as is described in more detail elsewhere herein. Training a local AI model may involve using inputs received from the one or more sensors. The trained local AI model may be sent to other edge devices.

In at least one embodiment, a blockchain containing newly trained local models is used to update the decentralized federated learning global model. Further, a consensus approach may be used to update the blockchain, which can increase reliability and minimize inaccuracy. In particular, proposed new blocks may be validated through anomaly detection. As will be appreciated by the skilled reader, the distributed or decentralized nature of the systems, devices and methods described herein is at least in part achieved by way of providing a plurality of independent devices communicating via peer-to-peer communication systems and protocols in order to implement federated learning systems for security threat detection and action. While blockchain technologies are proposed as an exemplary technology for safe data storage and transmission, the systems described herein are clearly not limited to the use of blockchain. Thus, other methods of storing and communicating data can additionally or alternatively be used.

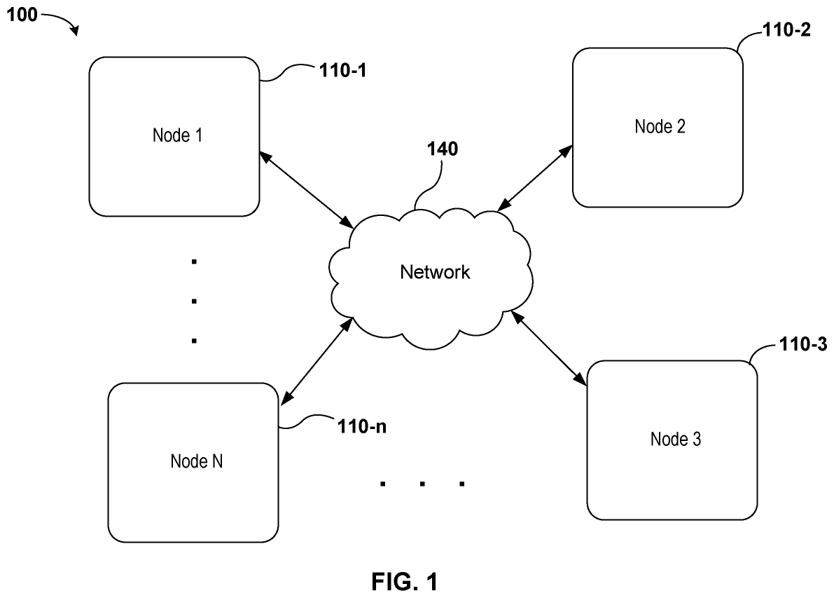

Reference is first made to FIG. 1, which shows a diagram of an example embodiment of a decentralized federated learning system 100 for security threat detection and reaction. The system 100 includes a plurality of nodes 110-1, 110-2, 110-3, 110-n in communication with each other via a network 140. Each node may be in communication with all other nodes in the system or with a subset of nodes in the system.

Each local node 110-1, 110-2, 110-3, 110-n may correspond to a device that provides the processing capability to process data sensed by sensors and/or process the local models and global model(s). In some cases, a local node may be an edge device capable of generating and/or receiving signals, via, for example, one or more sensors, and of communicating signals including sensor data. For example, the edge device may be a door sensor, a motion sensor, a security camera, a doorbell camera, a smart lock, a desktop computer, a laptop computer, a smartphone, a tablet, a smartwatch, a smoke detector, or any other IoT device. Local nodes 110-1, 110-2, 110-3, 110-n may be devices of a similar type or may be devices of a different type. For example, local node 110-1 may be a doorbell camera while local node 110-2 may be a smart lock. The edge device may include one or more processors for processing the data generated and/or received by the sensors of the edge device. A sensor may be any type of device that can detect a change in its environment, for example, an optical sensor, a proximity sensor, a pressure sensor, a light sensor, a smoke sensor, a camera, or a packet analyzer. Local nodes may be grouped based on common properties. For example, each group of nodes may correspond to a collection of devices associated with a particular user of the system. The collection of devices may be devices of the same type, for example, security cameras, or may be of different types. Nodes within a group may communicate with each other via network 140 and/or via a local network and, in some cases, may share one or more common local models. For example, a home security camera and a doorbell camera may share one or more common local models.

In some cases, the edge device of a node may be in communication with an external device that includes one or more processors, for example, if the edge device has limited processing resources, and the processor or processors of the external device may process data generated and/or received by the node device. In some other cases, one or more of the edge devices may have sufficient computing resources to process the data generated and/or received by the edge device. In some cases, the external device may be a computing system dedicated to interacting and managing data received from the edge device. In other cases, the external device may be a computing system that can interact with and manage data received from multiple edge devices and may be a general-purpose computing device configured to perform processes unrelated to the node device. Alternatively, in some cases, the external device may be a calculation-performing node that is part of the network of nodes. For example, the system may include one or more calculation-performing nodes configured to process data received from two or more nodes belonging to the same group of nodes. It should be noted that the terms “edge device”, “node”, and “local node” may refer to the combination of the edge device and the external device, unless otherwise specified.

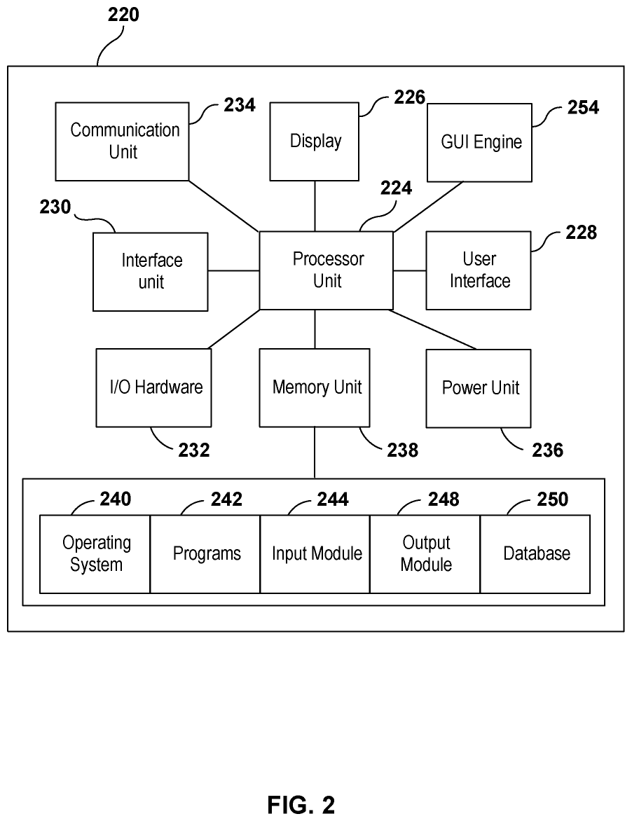

Reference is now made to FIG. 2, which shows a block diagram of an example embodiment of an edge device 220 that may be used in the system 100. One or more nodes may be implemented using device 220. The device 220, may be implemented as a single computing device and includes a processor unit 224, a display 226, an interface unit 230, input/output (I/O) hardware 232, a communication unit 234, a user interface 228, a power unit 236, and a memory unit (also referred to as “data store”) 238. In other embodiments, the device 220 may have more or less components but generally function in a similar manner. For example, the device 220 may be implemented using more than one computing device and/or processor unit 224. For example, the device 220 may be implemented to function as a server or a server cluster.

The processor unit 224 controls the operation of the device 220 and may include one processor that can provide sufficient processing power depending on the configuration and operational requirements of the device 220. For example, the processor unit 224 may include a high-performance processor or a GPU, in some cases. Alternatively, there may be a plurality of processors that are used by the processor unit 224, and these processors may function in parallel and perform certain functions.

The display 226 may be, but is not limited to, a computer monitor or an LCD display such as that for a tablet device or a desktop computer.

The processor unit 224 can also execute a graphical user interface (GUI) engine 254 that is used to generate various GUIs. The GUI engine 254 provides data according to a certain layout for each user interface and also receives data input or control inputs from a user. The GUI then uses the inputs from the user to change the data that is shown on the current user interface or changes the operation of the device 220 which may include showing a different user interface.

The interface unit 230 can be any interface that allows the processor unit 224 to communicate with other devices within the system 100. In some embodiments, the interface unit 230 may include at least one of a serial bus or a parallel bus, and a corresponding port such as a parallel port, a serial port, a USB port, and/or a network port. For example, the network port can be used so that the processor unit 224 can communicate via the Internet, a Local Area Network (LAN), a Wide Area Network (WAN), a Metropolitan Area Network (MAN), a Wireless Local Area Network (WLAN), a Virtual Private Network (VPN), or a peer-to-peer network, either directly or through a modem, router, switch, hub, or other routing or translation device.

The I/O hardware 232 can include, but is not limited to, at least one of a microphone, a speaker, a keyboard, a mouse, a touch pad, a display device, or a printer, for example.

The power unit 236 can include one or more power supplies (not shown) connected to various components of the device 220 for providing power thereto as is commonly known to those skilled in the art.

The communication unit 234 includes various communication hardware for allowing the processor unit 224 to communicate with other devices. For example, the communication unit 234 includes at least one of a network adapter, such as an Ethernet or 802.11x adapter, a Bluetooth radio or other short range communication device, or a wireless transceiver for wireless communication, for example, according to CDMA, GSM, or GPRS protocol using standards such as IEEE 802.11a, 802.11b, 802.11g, or 802.11n.

The memory unit 238 stores program instructions for an operating system 240 and programs 242, and includes an input module 244, an output module 248, and a database 250. When any of the program instructions are executed by at least one processor of the processor unit 224 or a processor of another computing device, the at least one processor is configured for performing certain functions in accordance with the teachings herein. The operating system 240 is able to select which physical processor is used to execute certain modules and other programs. For example, the operating system 240 is able to switch processes around to run on different parts of the physical hardware that is used, e.g., using different cores within a processor, or different processors on a multi-processor server.

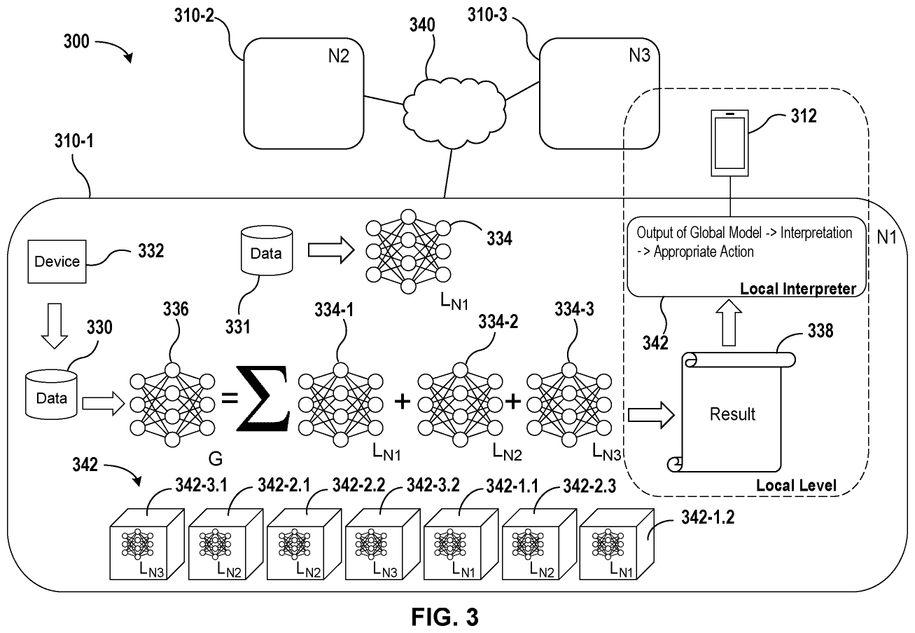

Reference is now made to FIG. 3, which shows a detailed schematic diagram of an example node 310-1 of a system 300 for AI-based security threat detection. The system 300 may be substantially similar to the system 100.

System 300 includes a plurality of nodes 310-1, 310-2, 310-3, three of which are illustrated for ease of illustration. The nodes may communicate with each other via a network 340. System 300 can include any number of nodes, each node including or corresponding to a device or to a group of devices, as described above with reference to FIG. 1. For illustrative purposes, a device 332 is shown separately, though it will be understood that all components shown inside the node 310-1 may be included in the device 332. Each node runs one or more global models 336 and maintains one or more local models 334. Each global model may be associated with a sensor event type, and each edge device may include one or more global models associated with a corresponding one or more sensor event types. For example, a home security camera may include one global model associated with a face detection sensor event type, a smart fire alarm or smoke detector may include a global model associated with a hazard sensor event type and a smart doorbell that includes a camera and microphone may include a global model associated with a video recognition sensor event type and a global model associated with an audio recognition sensor event type. The one or more global models associated with an edge device may be used in combination to identify a system event. Each node may further include a local interpretation module 342, as described in more detail elsewhere herein.

It will be recognized by those skilled in the art that while some of the embodiments disclosed herein relate to “face detection”, the systems, devices and methods described herein can alternatively or additionally detect other features. Such alternative or additional features include, but are not limited to, one or more of detecting the presence of a human or animal body and/or the geographic location of a human or animal body, detecting a clothing print and/or clothing colors, detecting human or animal body characteristics such as body height, body part shape, pattern of movement (e.g., gait), and/or voice. The detection of other optical or acoustic characteristics of a video feed would also be understood by the skilled reader to be within the scope of the present disclosure.

Each node or group of nodes may run one or more local models 334. For ease of illustration, a single local model is illustrated. However, it will be appreciated that each node may include more than one local model and local model 334 only constitutes an example local model. Each type of node device may be associated with one or more different types of sensor event, and each sensor event type may be associated with a different local model. A sensor event may be the capturing and analysis by a device of any type of real-world occurrence. For example, a face being detected by a camera may be a facial recognition event, a website being accessed and/or the type of website being determined may be an example of a cybersecurity event, and a motion sensor being triggered may be an example of an IoT home security event. For example, a home security camera may include a local model for facial recognition events. The local model 334 may be an AI model and may be configured to receive data 330 from the device, for example, from the one or more sensors on the device or the one or more sensors on a device associated with the device if the node is a calculation-performing device. The local model 334 may be trained to make a prediction. The type of prediction may depend on the input data received by the local model 334. For example, the local model 334 may return a prediction relating to a given event type. The event type may correspond to the event type associated with the sensor data received. For example, the local model associated with a home security camera may return a list of possible individuals captured in an image. As another example, an internet traffic monitoring model may predict whether a website accessed is “good” or “bad”, and a local model associated with a combination of IoT sensors may determine that a real-world event corresponds to an unknown system event. In some cases, the local model 334 may include features and parameters allowing identification of real-world events associated with sensor events. Each local model 334 may be associated with a local repository 331 that corresponds to a repository of captured events encountered by the node and/or that includes data received by the node.

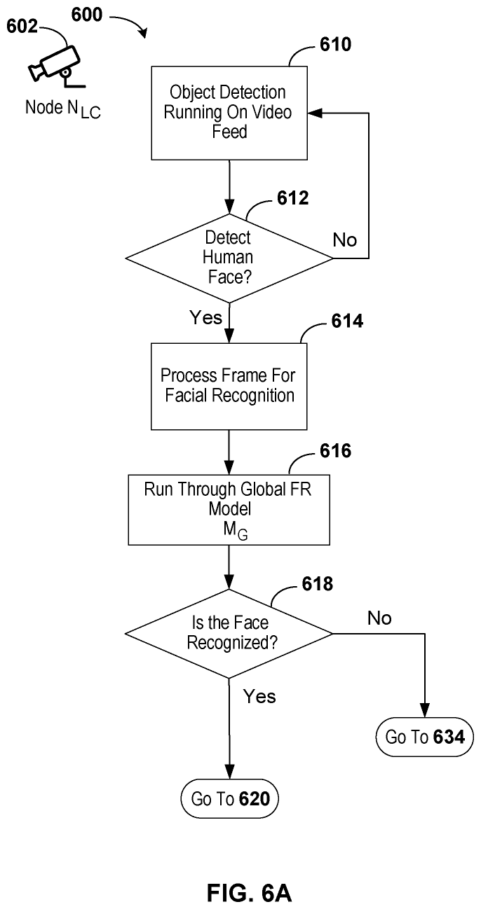

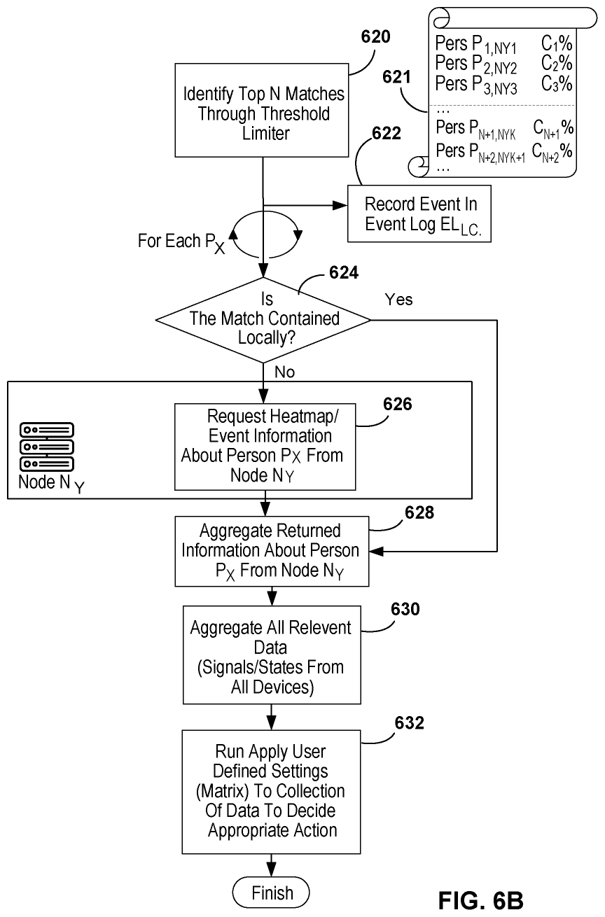

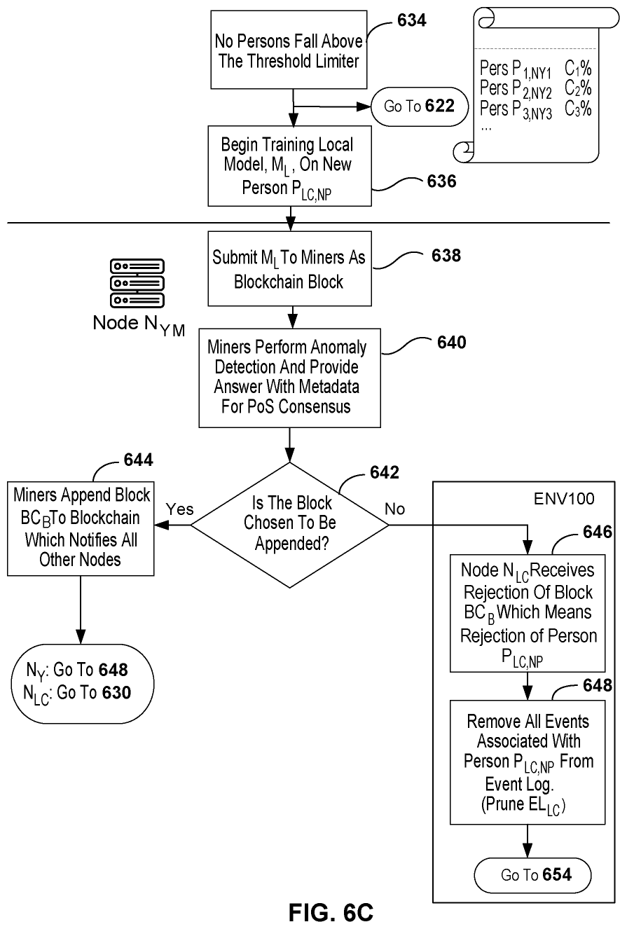

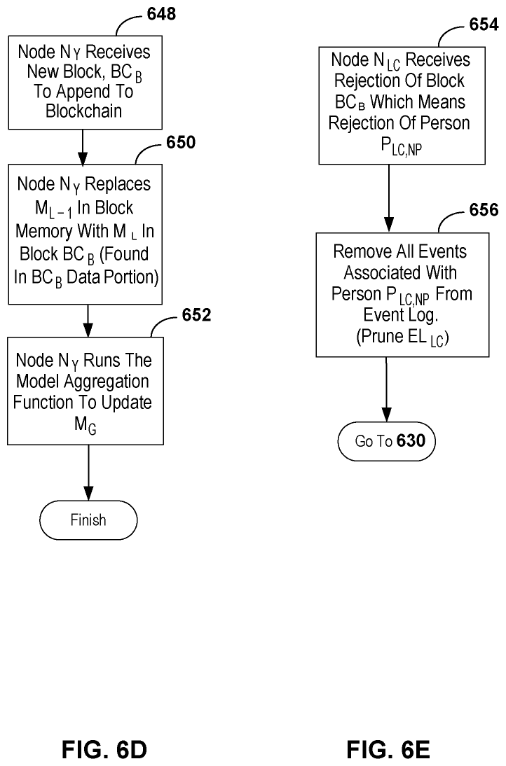

The repository 331 may be stored on the device 332 associated with the node or may be external to the device 332 associated with each node but accessible by the node and each node in the group of nodes. For example, the repository may be stored on any type of data storage that can be remotely accessed by the node or the group of nodes, for example, a network attached storage (NAS). The repository may contain snapshots of sensor events containing information about a sensor event encountered by the node. For example, as will be described in further detail below with reference to FIGS. 6A-6E, in the case of facial recognition, the repository may contain files and/or folders containing images of all individuals that have been previously encountered and identified by a camera at the node.

As described herein, the system 300 may be configured to detect real-world events, and categorize, and/or process security threats associated with the real-world events and label these sensor events as green, red, and yellow system events. These labels should be interpreted as being non-limiting unless stated otherwise. A green event represents an event that is a relatively low threat or no threat. A red event represents an event that is relatively a high threat. A yellow event represents an unknown threat. The system 300 may categorize, represent, encode, or store green, red, and yellow events in a manner that allows them to be communicated within the system and recognized by other parts of the system or devices external to the system as having their corresponding properties. The system 300 may use more or fewer labels as required.

When a yellow system event is encountered, as will be described in further detail below with reference to the global model, the local repository 331 may be used to train the local model 334. For example when a sensor event is determined to be a yellow system event, the local model 334 may be trained to recognize the sensor event such that if the sensor event is encountered again, the system 300 may determine that the sensor event has been previously encountered, corresponding to a green or red system event. The local repository 331 may contain parameters that allow a prediction to be made, which may contribute to the classification of the sensor events. Training the local model 334 may involve extracting features from the sensor event such that when the event is subsequently encountered, the event is recognized. Training features that allow future recognition of the sensor event may be used to update the local model and eventually, the global model, through processes described in more detail elsewhere herein.

A global model 336 is an AI model distributed across all nodes in the network. Similar to the local model 334, for ease of illustration, a single global model 336 is shown. However, each device may include one or more AI global models, depending on the type of device. Accordingly, nodes N2 310-2 and N3 310-3 run the same global model 336 as node N1 310-1. In some cases, each type of node device may be associated with one or more different types of events and each event type may be associated with a different global model. In other cases, each global model may be associated with multiple event types.

In some embodiments, the one or more global models 336 may be initialized using publicly available datasets before being trained and updated by the nodes in the network. When a node joins an existing network, the node may download the current local models of other nodes in order to establish its own initial local model. Additionally, or alternatively, the initializing publicly available set relating to the node device type may be transmitted to the node for use in establishing its own initial local model. In some embodiments, the node may download a blockchain containing the local models of the nodes in the network, construct its own local model from the initialized dataset, then submit a new block to the blockchain containing the node's newly trained local model. As the node encounters new sensor events, the local model of the node is updated, as described previously. The global model 336 may be stored by the node device 310-1. The node device can use the global model 336 to make a prediction relating to the sensor event based on data 330 received from the node device. The data 330 received from the node device may be preprocessed before being inputted into the global model. For example, the data may be processed to remove excess data, produce data of a format suitable for the global model 336, augment the data set to create additional training data, reorder the data, or to window the data.

Data 330 from the node device 332 may be inputted into the global model 336, and the global model 336 may return a result 338. For example, the global model 336 may be configured to return a prediction. The type of prediction is dependent on the input data 330 received by the global model. For example, each global model 336 may return a prediction relating to a given event type, based on the event type associated with the sensor data 330 received from the node device. In some cases, the prediction may correspond to an identification of the sensor event or a real-world event associated with the sensor event. For example, in response to receiving an image of a face, the global model 336 associated with facial recognition type events may identify the person shown in the image.

In at least one embodiment, the result 338 may be interpreted by the local interpretation module 342, as is described in more detail elsewhere. By configuring each node with the global model 336, sensor events can be processed locally by each node, limiting the transfer of private data away from the node.

Each global model 336 may correspond to a sum or an aggregation of the local models 334-1, 334-2, 334-3 of each node of an event type. Accordingly, the global model 336 may be stored by the node as a collection of local models 334-1, 334-2, 334-3. In some cases, the global model 336 may include the current local models of the local nodes and previous versions of the local models of the local nodes. Previous versions of the local models may be retained, for example, in the event that a more current version of the local model is corrupted or otherwise damaged. The system 300 may be configured to retain a predefined number of previous versions.

In some cases, the sum may be a weighted sum and the weight allocated to each node may be based on a measure of the trustworthiness of the node. For example, nodes which have processed more system events, or which have processed more system events within a defined time period may be assigned a higher weight. As another example, nodes may be ranked by age and older nodes may be assigned a higher weight. As another example, nodes may be assigned a trustworthiness score by an evaluator, and nodes with a higher trustworthiness score may be assigned a higher weight. By aggregating local models, the global model 336 can leverage knowledge from nodes across the network, allowing each node to make a prediction relating to a sensor event that may not have been previously encountered by the node.

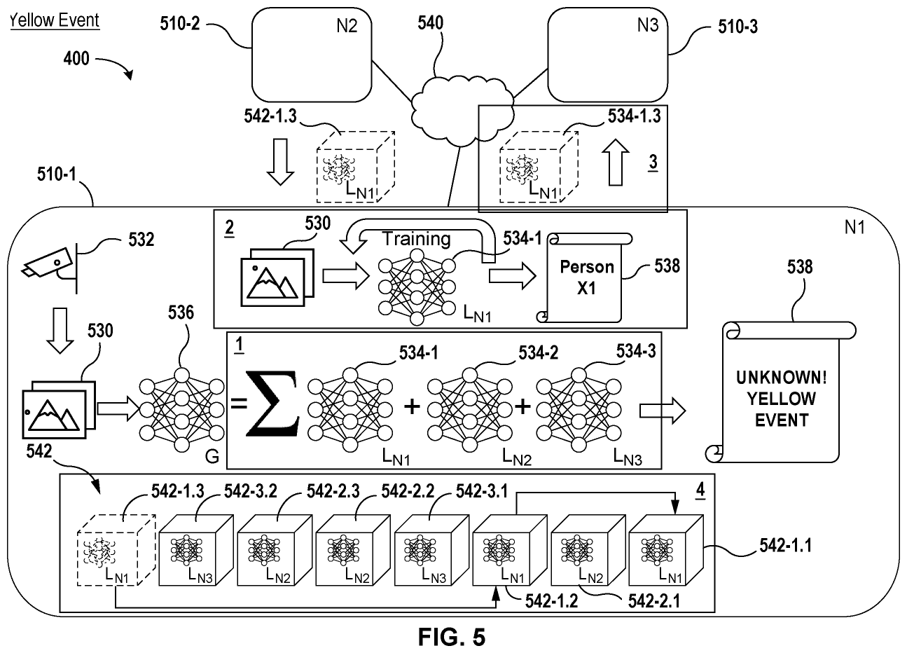

The global model 336 may be updated when the global model 336 fails to return a prediction with sufficient confidence. For example, the global model 336 may fail to return a prediction with sufficient confidence when a new sensor event, which has not been previously encountered by the nodes in the network, is encountered by a node in the network. In other words, the global model 336 may be updated when a yellow event, which will be described in further detail with reference to FIG. 5, is encountered.

In at least one embodiment, each node may additionally include a local interpretation module 342. The local interpretation module 342 can be configured to receive a result 338 from the global model and interpret the result 338 using locally relevant parameters. For example, the local interpretation module 342 may be a matrix that associates results with specific categories, actions, and/or responses. Table 1 shows a simplified example of a local interpretation matrix for a system of security cameras associated with a user.

TABLE 1

| Camera Location | Red Event | Green Event | Yellow Event |
|---|---|---|---|
| Street | Notify Owner | Do Nothing | Notify Owner |
| Yard | Sound Alarm | Do Nothing | Notify Owner |
| Door | Notify Police | Unlock Door | Sound Alarm |

As shown in Table 1, each system event (Red, Green and Yellow) may be associate with a different action (Do Nothing, Unlock Door, Notify Owner, Sound Alarm, Notify Police) depending on the location being monitored by the edge device (Street, Yard, Door). As such, the local interpretation layer provides flexibility and personalization of system responses to system events determined by global AI models.

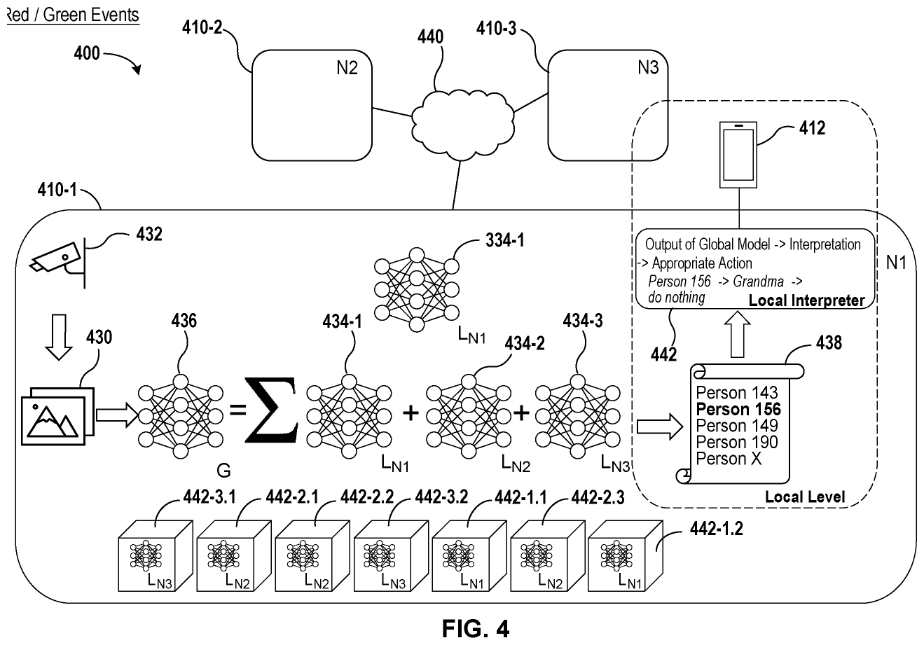

The interpretation of the result may be based on parameters or preferences defined by the user. These parameters or preferences may be predefined by the user or may be learned by the local interpretation module 342 based at least in part on the user's predefined preferences and/or on the user's previous responses to sensor events and/or system events. In some cases, the local interpretation module 342 may assign a security category to the event, based on the result of the global model 336. For example, the local interpretation module 342 may assign system events into green or red categories, as will be described in further detail below with reference to FIGS. 4-5. An event may be categorized as a green or red event based on the parameters defined by the user. In some cases, the local interpretation module 342 may additionally associate specific events with specific responses or actions. For example, in response to detecting a particular event, the local interpretation module 342 may communicate with a user device 312 to provide notifications. The user device may be any device capable of communication notifications to the user, for example, a smartphone, a desktop computer, a laptop computer, a tablet, or a smartwatch. The notification may inform the user that a green, red, or yellow event has been detected and/or may request the user to take an action in response to a system event. For example, in response to a specific red event, the system 300 may be configured to contact and alert authorities.

In some embodiments, the local interpretation module 342 may also recommend an action, for example, based on actions taken by other nodes in the system.

As will be appreciated by the skilled reader, while the present example describes green, red and yellow events, other schemes for categorizing events and levels of security threat may readily be used within the scope of the systems, methods and devices disclosed herein.

As described above, the local interpretation module 342 may be configured to assign a category to the result 338 that is output by the global model 336. Green events correspond to events that are known and identifiable by the global model 336 and that are associated with a positive outcome or a low security threat, based, for example, on user-defined parameters. Red events correspond to events that are known and identifiable by the global model 336 and that are associated with a negative outcome or a high security threat. Both red and green events are associated with events that have been previously encountered by any node in the system 300. Because red and green events are events which are known by the global model 336, red and green events typically do not involve updates to the global model 336.

Green system events, for example, may correspond to sensor events that have been identified by the local interpretation module 342 as not posing a security threat. For example, green events may correspond to events that have been cleared by the user associated with the node or group of nodes. Using the example of facial recognition, a green event may correspond to a family member being detected by a security camera belonging to the user. Red events may correspond to events that pose or may potentially pose a safety threat. Red system events may correspond to events that have been specified by the user associated with the node or group of nodes as dangerous or causing disturbance. For example, using the example of facial recognition, a red event may correspond to the detection of a person that has been identified by the user as disruptive. As another example, in the case of cybersecurity, a red event may correspond to the detection, analysis and categorization of an attempt to access a fraudulent or nefarious website.

Yellow system events correspond to events for which the global model 336 is unable to return a prediction with sufficient certainty. A yellow event, for example, may correspond to a sensor event that has not been previously encountered by any node of the system 300 and accordingly to which no action is associated, or to events that cannot be identified by the global model 336 with sufficient certainty to determine if the event has been previously encountered. When a yellow event is encountered, a new record representative of the event may be created by the node 310-1. The local model 334 may be trained using the data that resulted in a yellow event being identified to determine parameters or features that allow future recognition of the event. When the event is subsequently re-encountered, the system 300 may associate the new event with the existing record.

In some cases, when a sensor event is determined to be a yellow system event, the event may be forwarded to the user device 312, and the user device 312 may request an input from a user. Alternatively, or in addition thereto, the user preferences defined by the user may indicate a set of actions to be taken when a yellow event is encountered. For example, upon detection of a yellow event, the system 300 may transmit a notification to the user device 312.

In at least one embodiment, the determination of a green or red event as opposed to a yellow event may be based on the global model 336, while determining whether a given event is a red or green event may be dependent on the local interpretation module 342 of the local node.

In at least one embodiment, the local models constituting the global model 336 may be stored in a blockchain 344, each block corresponding to a local model. In other embodiments, only the differences between a newly trained local model and its previous version are stored in each new block. The entire blockchain 344 may be stored on the local node device 332, and the local models 334 may be retrieved by the processor of the device and aggregated or summed to generate the global model 336 when sensor data is received. Upon detection of a yellow event, a training process may be performed to update the local model 334, and the global model 336 may be updated, as will be described in further detail below, with reference to FIG. 5. Upon completion of the training process, a new block may be added to the blockchain, containing the latest trained local model 334. In at least one embodiment, the new block may undergo a validation process before it is appended to the blockchain. Storing local models in a blockchain increases security, ensuring that models are not easily removed from the system 300 without consensus and preventing local models from being tampered. As will be appreciated by the skilled reader, however, local and global models may be stored locally using known memory storage systems and methods.

As shown in FIG. 3, the blockchain may contain a current version of each local model 344-1.1, 344-2.1, 344-3.1. In some cases, the blockchain may additionally include one or more previous version of the local models 344-1.2, 344-2.2, 344.2-3, 344-3.2 and in some cases all versions of a local model. In some cases, it may be advantageous to retain a previous version of a local model in the event that a subsequent version of a local model is damaged. It may, however, be advantageous to remove outdated models, to reduce memory requirements.

Accordingly, in at least one embodiment, the size of the blockchain may be periodically reduced/pruned. In such embodiments, outdated versions of local models may be discarded, for example, when a new version of a local model is appended. In some cases, only the most recent local model of each node may be kept.

In conventional blockchain systems, the entire blockchain is traversed to find the most up to date models. Accordingly, when an update to a local model is sent to the blockchain, to reduce the size of the blockchain, the entire blockchain is traversed to find the previous iteration of the local model. By contrast, in some embodiments described herein, the entire blockchain does not need to be traversed because each block used to store a newly trained local mode also includes a pointer to the previous version of that local model.

In particular, each block may include a pointer to the last block that relates to the same node. Accordingly, when a local model is updated in response to a yellow event and the model is transmitted to the blockchain and accepted by mining nodes, the block includes a pointer to the last version of the local model. Accordingly, when the size of the blockchain is reduced, for example, to reduce memory requirements and storage space, the system may traverse the blocks starting from the last block of the blockchain, and retrieve previous versions of local models, which can be discarded. This process additionally reduces the time needed to reduce the size of the blockchain.

Reference is now made to FIG. 4 which shows a schematic diagram of a process flow of an example embodiment of a method used by system 400, which includes a plurality of nodes, three of which, N1 410-1, N2 410-2, N3 410-3, are shown for ease of illustration, to process a security threat classified as green or red. System 400 may be substantially similar to system 100 and/or system 300. During operation, the one or more sensors of node device 432 receive and/or generate data 430. In the example shown in FIG. 3, node device 432 is a camera and the signal 430 is an image. For example, signal 430 may be a frame captured from the camera video feed. The signal 430 is then run through the global model 436. As described previously with reference to FIG. 3, the global model 436 may be a sum or an aggregation of local models 434-1, 434-2, 434-3.

The global model 436 can return a result 438, which may be a prediction. For example, the global model 436 may identify the event detected. In the example shown, the global model 436 may identify that the image 430 corresponds to an image of “Person 156”. The identifier “Person 156” may correspond to an identifier given to a person that is recognized by the global model 436. In determining that the person pictured in the image 430 is associated with identifier “Person 156”, the global model 436 may return a list of all persons known by the system 400 and an associated confidence score. Each event known by the global model 436 may be associated with a separate identifier. Generally, the global model 436 may return a list of all events known by the model 430, and a confidence score that the signal/information 430 received or generated by device 432 is associated with an identifier corresponding to an event.

The local interpretation module 442 may receive and interpret the output of the global model 436. In at least one embodiment, the local interpretation module 442 may label the output received from the global model 436. In the example shown, the identifier “Person 156” corresponds to a person known by node 1 410-1, with label grandma. The label associated with each identifier of the global model 436 may vary, depending on the local interpretation module. Accordingly, “Person 156” may be labelled grandma by the local interpretation module 442 of node N1 410-1 but may be associated with a different label by the local interpretation module of node N2 410-2. Each local interpretation module may associate a subset of identifiers contained in the global model 436 with labels. For example, each local interpretation module may include a matrix, associating global model identifiers with local interpretation module labels. The local interpretation module may also determine the appropriate action to be taken. In the example shown, grandma is associated with no action. In other cases, grandma may be associated with a notification transmitted to the user device 412 and the system 400 may transmit a notification that grandma has been seen by the camera 432.

In the example shown, as the event is determined to be a green event, no updates are made to the global model. Accordingly, no blocks are added to the blockchain containing blocks 444-3.1, 444-2.1, 444-2.2, 444-3.2, 444-1.1, 444-2.3, 444-1.

In at least one embodiment, the local interpretation module 442 includes a matrix associating labels with actions.

In at least one embodiment, the local interpretation module 442 interprets the result 438 output by the global model 436 directly and the global model identifier may be associated with actions.

Reference is now made to FIG. 5, which shows a schematic diagram of a process flow of an example embodiment of a method used by system 500, which includes a plurality of nodes, three of which, N1 510-1, N2 510-2, N3 510-3, are shown for ease of illustration, to process a security threat classified as yellow. System 500 may be substantially similar to system 100, system 300, and/or system 400. Similar to FIG. 4, a node device 532 generates or receives a signal/information 530. The signal/information 530 is then run through a global model 536. As described previously with reference to FIG. 3, the global model 536 may be a sum or an aggregation of local models.

If the global model 536 is unable to make a prediction with sufficient confidence, a yellow event is recorded, as described above with reference to FIG. 2.

In at least one embodiment, when a yellow event is recorded, the local model 534-1 of the node may be trained taking into account the local signal/information 530 that led to a yellow event being recorded as shown by box 2. In such embodiments, the local model 534-1 is incrementally trained and when a yellow event is encountered, the local model 534-1 is updated to include information relating to the yellow event. Alternatively, when a yellow event is recorded, the local model 534-1 of the node may be trained using all of the data associated with the node that encountered the yellow event. For example, in some cases, in between yellow events, that is, in between system events that cause the local model 534-1 to be trained, the node may receive new information about green or red events. When the local model 534-1 is subsequently retrained, the local model 534-1 may be trained using the local signal/information 530 that led to the yellow event being recorded and using any additional information received that may have been received since the local model 534-1 was last trained. Training the local model 534-1 of the node 510-1 which encountered the yellow event can allow the local model 534-1 and the global model 536 to derive data about the event such that if the event is subsequently re-encountered, a prediction about the event may be made by the global model 536. The local model may be trained as a multiclass classification using a back propagation on feed forward networks algorithm implementing stochastic gradient descent. Training may be performed over some amount of epochs until testing accuracy reaches an acceptable error rate.

Once the local node has trained the local model 534, the global model 536 may be updated. As described previously with reference to FIG. 3, in at least one embodiment, a blockchain may be used to update the global model. In such embodiments, the results of the training may be transmitted as a block 544-1.3 to the blockchain.

The block 542-1.3 may be submitted to mining nodes for approval. In some cases, anomaly detection may be performed on the block 544-1.3. A block may be anomalous if it may be detrimental to the effectiveness of the global model 536. In some cases, to perform anomaly detection, mining nodes may compute the error rate of the new global model that would be generated if the block 544-1.3 is appended to the blockchain. Mining nodes may be local nodes that have elected to act as miners. For example, mining nodes may be local nodes with large (or sufficient) computational resources that may be capable of performing anomaly detection faster and/or more accurately than the local node which encountered the event. By using a blockchain with mining nodes, updates to the global model may be approved before they are accepted, potentially increasing the accuracy and reliability of the system 500. Further, the use of mining nodes can allow anomaly detection to be performed by a select number of nodes, rather than all nodes in the system 500, which may, in some cases, have limited computational resources, thereby decreasing computational time and resource utilization.

For example, the mining nodes may precompute the new global model, determine the error rate using local data from the mining node or local data associated with a network of devices to which the mining node belongs, and determine the current error rate using the current model. In some other examples, the mining nodes may also use data from public sources, for example, data from the initializing data set. In some embodiments, different calculated error rates may be compared. If the difference in error rate is within a predefined acceptable threshold, the mining node may transmit a proof-of-stake (POS) message indicating that the new block is acceptable. The mining node may also transmit metadata relating to the node, such as the number of events previously encountered by the node, the number of yellow events previously encountered by the node, the age of the node, or any other metric that may serve as a measure of trustworthiness of the node, including a trustworthiness score assigned to the node by an evaluator.

In at least one embodiment, all PoS responses submitted within a predefined time window are considered and the block 542-1.3 is accepted or rejected based on the responses received. For example, a response may be randomly chosen given a weighted vote based on the number of “accept” and “do not accept” responses. Alternatively, each mining node may be assigned a weight, based on a measure of trustworthiness of the node, and a weighted average may be computed to determine if the block 542-1.3 should be accepted or rejected.

In some cases, one or more mining nodes may be rewarded using a cryptocurrency (or other form of reward) for performing anomaly detection. For example, the first mining node to report a response may be rewarded. Alternatively, a randomly selected mining node which reported a response within the predefined time window may be rewarded.

Referring now to FIGS. 6A-6E, shown therein are flowcharts of an example method 600 of processing a security threat using facial detection in accordance with the system of FIGS. 1-3. In this example embodiment, the local node N_{LC} includes a camera 602 providing a video feed. For example, the camera may be a security camera or a doorbell home security camera associated with a user of the system. The camera 602 may provide a continuous video feed and may be enabled with object detection and facial recognition capabilities.

At 610 and 612, the camera performs object detection until a face is detected. In the case of a doorbell home security camera, for example, face detection may occur when, for example, a person arrives at the user's door. When a face is detected by the camera, a clip of the face may be isolated. For example, an image of the face may be captured and the method proceeds to 614.

At 614, the image may be preprocessed. The image may be preprocessed by a processor on the camera 602. Alternatively, the image may be transmitted to an external processor for processing, for example, if the camera 602 does not include image processing capabilities. Preprocessing functions can include, but are not limited to, grey scaling, image resizing, removal of lighting effects through application of illumination correction, face alignment, and face frontalization. Any combination of these preprocessing functions and additional preprocessing functions may be performed on the image.

At 616, the image or preprocessed image is run through the global model. As described above with reference to FIG. 3, the local node may be configured to run the global model.

At 618, the global model determines if the person pictured in the image is known or unknown. A known person is a person that is recognized by the system, such as a person who has previously interacted with the system. If the global model recognizes the face, the method proceeds to 620. If the model does not recognize the face or does not recognize the face with sufficient confidence, the method proceeds to 634 and the event is categorized as a yellow event.

The global model may return a list of all persons known by the model and an associated confidence level that the facial image fed into the global model belongs to a particular person. Each row in the list may include an identifier given to an image of a person at the end of the first event associated with the person and a confidence score that the facial image run through the global model belongs to the person associated with the identifier as shown in box 621. For example, for a given row N, a unique person K first detected at node N_{y}, where N_{y} is any node in the network other than the current node which captured the image, a label P_{N, NYK} may be assigned to this person. Alternatively, each row may include an identifier given to an image of a person by a node, a node identifier, and a confidence score that the facial image run through the global model belongs to the person associated with the identifier. In such cases, there may be more than one row associated with the same person. For example, P_{1, 1,123} and P_{2, 3, 234}, corresponding to “Row 1, Person 123” at node 1 and “Row 2, Person 234” at node 3, respectively, may correspond to the same person.

At 620, the local node identifies the top matches. To identify the individual captured in the image, a threshold limiter function may be used. A limiter function may be defined as the limited selection of rows based on certain criteria inherent in each row produced by the global models multi-classed sensor event classification (SEC) prediction (confidence level). For example, if a global model produces a list of known SECs paired with a confidence level per SEC, the limiting function may then select only the rows in the list with a confidence level superior to a predetermined threshold, for example 95%. In some embodiments, the limiting function may then select only the first N rows, for example 10 rows in the list after the list is sorted in ascending order based on confidence level of each SEC. In some embodiments, the threshold limiter function may select the row in the list associated with the highest confidence or select the row with the highest confidence out of all the rows associated with a percentage confidence higher than predetermined threshold, for example 90%. All of the rows may correspond to the same person, sensed (i.e., encountered) at different nodes.

At 622, the event may be recorded in an event log. The record associated with the event can include information including, but not limited to, a specific node ID, a person identifier, a time of day, a gait detection result following analysis and detection of a person's gait (i.e., manner or walking/moving), or an action taken or requested due to the event.

At 624, the local node determines if the match is contained locally. If the match is contained locally, the method optionally proceeds to 628. Otherwise, the method proceeds to 630. The match may be contained locally if the person identified using the global model or the possible persons identified by the global model has previously interacted with the local node N_{LC} and is accordingly used to train the associated local model of the node. For each match or for the top match, depending on the threshold limiter function used, the node may determine if the match is contained locally.

If the match is not contained locally, the method proceeds to 626. At 626, the node may request event information about the individual that was identified at 620 from the nodes that have previously encountered the individual identified. For example, in some embodiments, the system may identify the node that has the highest level of confidence that the person in the image was a given person Pₓ. In some embodiments, the system may compile information (e.g., location information) relating to each instance of person Pₓ being identified by one or more nodes with a confidence level above a threshold. Such compiled information relating to an individual may be referred to herein as a “heatmap”. The method then proceeds to 628.

At 628, in at least one embodiment, the local node may aggregate information about the person identified from all nodes which have previously encountered person Pₓ. The aggregated information may take the form of a list or a heatmap containing information including, but not limited to, a node identifier NY, a person identifier, a frequency of occurrences a person P_{X} has been seen by node NY limited to some previous time frame and an approximate location information (e.g., a zip code, an address). For example, a list can be compiled based on each row reporting the frequency of views of person P_{X} per day, per node N_{Y} over a predetermined time window, for example 60 days and/or in a predetermined area. In some cases, aggregating information about the person identified can help determine the appropriate response to a sensor event.

At 630, the local node aggregates all other relevant data. For example, if a network of devices associated with a particular user includes multiple edge devices, the local node may aggregate data received from the other sensors in the network. Data from a porch camera may accordingly be aggregated with data from a backyard camera.

At 632, the local node determines the appropriate action to be taken, based on the result obtained at 630. The local node may apply user defined settings to the collection of data to determine an appropriate action. For example, the local interpretation module of the node may interpret the result of the global model to determine whether the event should be labelled a green or red event. For example, the local interpretation module may include a matrix that associates specific people with green or red events or with specific actions as described previously with reference to FIGS. 3-4.

If at 618, the face is not recognized by the global model, for example, the threshold limit function returns no results, the method 600 proceeds to 634, corresponding to a yellow event.

The yellow event may be recorded in the event log at 622. The record associated with the event can include information including, but not limited to, a specific node ID, a person identifier, a time of day, a gait detection result, or a placeholder for an action taken or requested.

At 636, the local model of the node is trained. The local node may add the unrecognized face to its local repository of faces. For example, the local node may store the image captured in a local directory. In some cases, for example, the local node may maintain a directory of previously accepted people organized in folders, and store the image captured in a new folder. Subsequent images associated with this individual may be stored in the same folder. The directory may be stored on the camera or may be stored on an external storage device accessible to the camera, for example a network attached storage (NAS). In cases where multiple cameras are associated with one user, it may be advantageous to store the images on an NAS.

In some embodiments, the node may train the local model using a multi-class classification using standard back propagation on feed forward networks by implementing stochastic gradient descent over some amount of epochs until testing accuracy reaches some acceptable error rate.

At 638, when the local node has trained the local model, the trained local model is placed into a blockchain block and transmitted to all participating mining nodes N_{YM}.

At 640, when the mining nodes N_{YM} receive the block submitted by the local node, each of the mining nodes performs anomaly detection to verify that the block does not contain a model that is detrimental to the effectiveness of the global model. For example, the mining nodes may precompute the new global model that would be generated if the local node block is appended to the blockchain and compute the error rate associated with the people in the node's own directory using the new global model with the error associated with the current global model. If the difference in error rate is within a predetermined acceptable threshold, the mining node may indicate that the new block is acceptable. If the mining node determines that the block may contain a model that is detrimental to the effectiveness of the global model, the mining node may indicate that the model is not acceptable. The mining nodes may transmit a PoS response that includes an “accept” or a “do not accept” message, and metadata associated with the mining node. For example, a number of unique persons in the directory associated with the mining node may be included in the PoS response. The number of unique persons in the directory associated with the mining node may be an indication of the trustworthiness of the node.

At 642, the mining nodes determine if the block is to be appended. Responses that are submitted by mining nodes within an acceptable amount of time, for example, a predetermined amount of time, are aggregated by the mining nodes. A response may be pseudo-randomly chosen by way of a weighted vote based on the number of accepted/not accepted responses. For example, all responses received before a cut-off time may be summed, and a chance of acceptance may be calculated based on the number of nodes that accepted the new block and the total number of responses received. A random number may then be generated, such as between 0 and 1 inclusively, and if the random number is smaller than or equal to the acceptance rate, the block may be accepted. For example, for a 75% acceptance rate, a random number smaller than or equal to 0.75 would result in the new block being appended. As will be appreciated by the skilled reader, other methods for determining whether a block will be appended are also possible.

If the block is accepted, the method 600 proceeds to 644 and the block is appended to the blockchain. If the block is not accepted, the method 600 proceeds to 646. If the block is accepted, the local node proceeds to 630 (described above), and all other nodes proceed to 648. At 644, the mining nodes append the block to the blockchain and notify all other nodes in the network of the change. At 648, all nodes in the network other than the node responsible for the system event receive the new block.

By appending the new block, the global model is updated. The new global model may be expressed as a weighted sum of models using the following equation:

M_{G}=ΣΦ(M_{X})

where Φ(M_{X})=α×M_{L}, where α is a fraction representative of the trustworthiness of the node and M_{L} is the local model. The measure of trustworthiness may be based on the number of unique persons in repository 331 associated with the node or may be based on the number of times a person from the node is identified when compared to other nodes.

At 650 each of the nodes in the network may replace the previous model associated with the local node in memory with the new model.

At 652, each node then runs a model aggregation function to update the global model.

If the block is not accepted, the method proceeds to 654. At 654, the local node N_{LC} receives a message that the block was rejected by the miners.

At 656, data associated with the yellow event is discarded. Discarding information relating to an event that will lead to an anomalous result and that is detrimental to the effectiveness of the global model may save resources, as only information that is useful is retained in the global model.

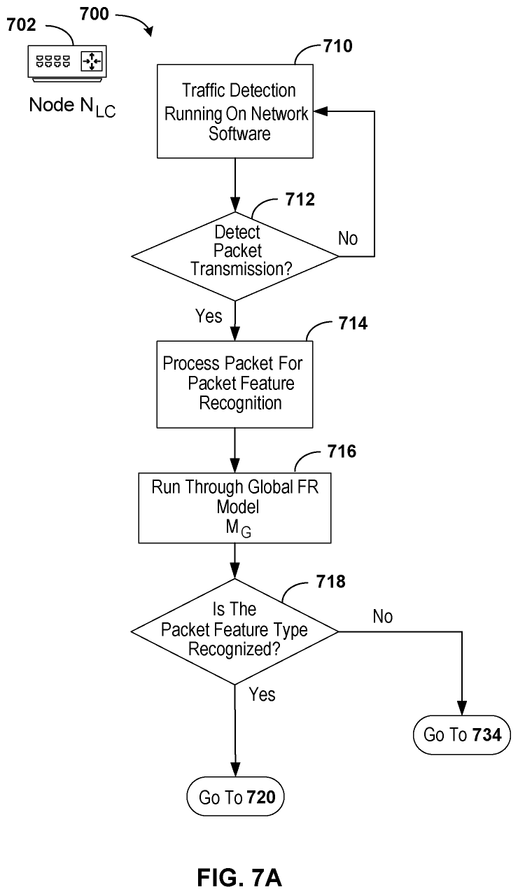

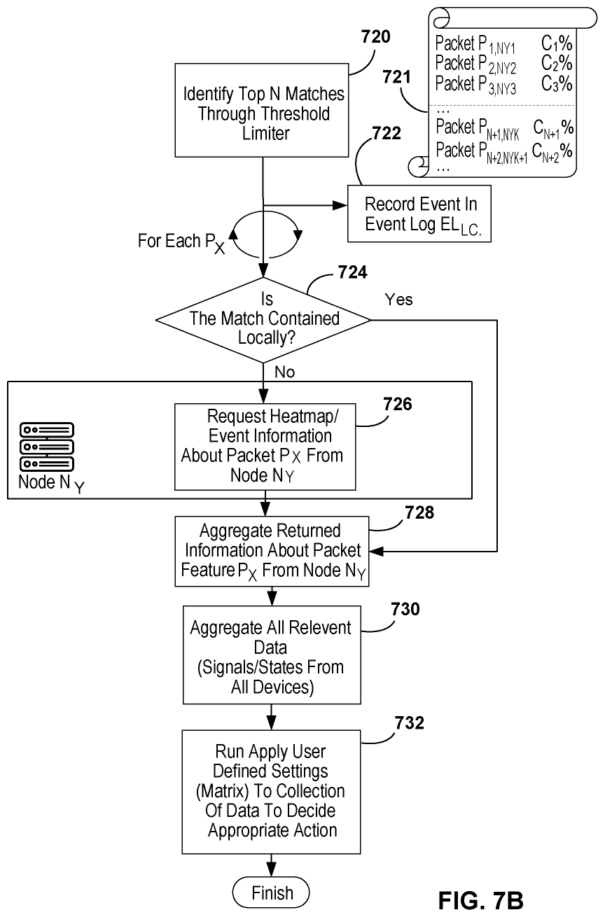

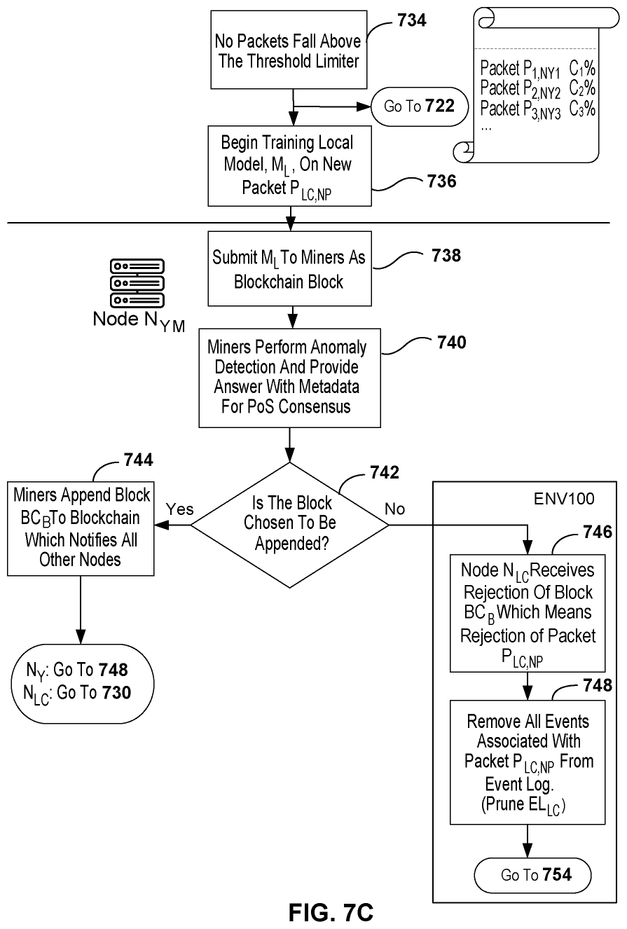

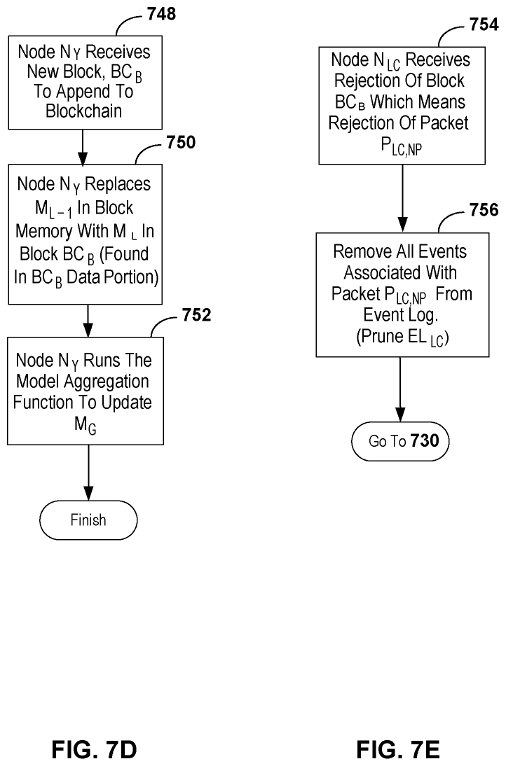

Referring now to FIGS. 7A-7E, shown therein are flowcharts of an example method 700 of processing a security threat using traffic monitoring of a home network in accordance with the system of FIGS. 1-3. In this example embodiment, the local node N_{LC} includes a networking device 702 capable of monitoring network traffic. For example, the networking device may be a router, a hub, or a cable modem managed by or administered by a user of the system. The networking device 702 may include both the hardware and the software required to manage network data (e.g., Internet data, LAN data) being transmitted to and from the system.

At 710 and 712, the networking device 702 performs traffic/packet detection and/or inspection (or traffic monitoring) while packet transmission is occurring. In the case of a router managing the transmission of Internet data, for example, traffic detection may occur when, for example, a download begins. When a download is detected by the networking device, a packet containing information about the download may be isolated. As used herein, a “packet” may refer to a single data packet or a collection of data pertaining to a particular function (e.g., an HTTP request) or data structure (e.g., a web page, a download, a song, a video). For example, a source web page may be captured and the method proceeds to 714.

At 714, the packet may be processed to detect a packet type. The packet may be processed by the router software of the networking device 702. Alternatively, the packet may be transmitted to an external processor for processing, for example, if the networking device 702 does not include router software. Processing functions can include, but are not limited to, extracting packet features, such as web site data, metadata, multicast identifiers. Any combination of these preprocessing functions and additional preprocessing functions may be performed on the packet.

At 716, the packet or processed packet is run through the global model. As described above with reference to FIG. 3, the local node may be configured to run the global model. In some embodiments, traffic patterns of multiple packets may also, or instead, be run through the global model. Such traffic patterns may be determined using a network traffic monitor.

At 718, the global model determines whether one or more features of the packet (e.g., source and destination addresses, video content, encrypted content) are known or unknown. In some embodiments, traffic patterns of multiple packets may also, or instead, be used. A packet feature may be any information relating to the structure or content of a network packet which can be extracted and analyzed. Examples of a packet feature include, but are not limited to, source address, destination addresses, type of service, total length, protocol, checksum, data/payload, or any combinations thereof.

A known packet feature is a packet feature that is recognized by the system, such as a packet feature that has previously interacted with the system. If the global model recognizes the packet feature(s), the method proceeds to 720. If the model does not recognize the packet feature(s) or does not recognize the packet feature(s) with sufficient confidence, the method proceeds to 734 and the event is categorized as a yellow event.

The global model may return a list of all packet feature types known by the model and an associated confidence level that the packet features fed into the global model belong to a particular packet feature type(s). Each row in the list may include an identifier given to a packet feature type at the end of the first event associated with the packet feature(s) and a confidence score that the packet feature(s) run through the global model belongs to the packet feature type(s) associated with the identifier as shown in box 721. For example, for a given row N, a unique packet feature K first detected at node N_{y}, where N_{y} is any node in the network other than the current node which captured the packet, a label P_{N, NYK} may be assigned to this packet feature. Alternatively, each row may include an identifier given to a packet feature type, a node identifier, and a confidence score that the packet feature type run through the global model belongs to the packet type type associated with the identifier. In such cases, there may be more than one row associated with the same packet feature type.

At 720, the local node identifies the top matches. To identify the packet feature type of the packet feature, a threshold limiter function may be used. The threshold limiter function may, for example, select the row in the list associated with the highest confidence, select the row with the highest confidence out of all the rows associated with a percentage confidence higher than predetermined threshold, for example 90%, or choose all rows associated with confidence levels above a predetermined threshold, for example 95%. All of the rows may correspond to the same packet feature type, encountered at different nodes.

At 722, the event may be recorded in an event log. The record associated with the event can include information including, but not limited to, a specific node ID, a packet identifier, a time of day, or an action taken or requested due to the event.

At 724, the local node determines if the match is contained locally. If the match is contained locally, the method optionally proceeds to 728 or proceeds to 730. The match may be contained locally if the packet feature identified using the global model or the possible packet features identified by the global model have previously been used to train the local model of local node N_{LC} and is accordingly included in the repository of the local node. For each match or for the top match, depending on the threshold limiter function used, the node may determine if the match is contained locally.

If the match is not contained locally, the method proceeds to 726. At 726, the node may request event information about each of the packet features identified at 720 from the nodes that have previously encountered the packet features identified. For example, the system may identify the node that has the highest level of confidence that the packet feature was a given packet feature type Pₓ and identify each instance of the packet feature being identified. In at least one implementation, for each packet feature that makes it through step 720, the system retrieves that packet feature's information either locally or by requesting the information from the other nodes. The method then proceeds to 728.

At 728, in at least one embodiment, the local node may aggregate information about the packet feature identified from all nodes which have previously encountered packet feature type Pₓ. For example, the system may gather event logs associated with the packet feature type identified from participating nodes in the network. The event logs may be aggregated and/or summarized and used at 732 to determine an action to be taken.

At 730, the local node aggregates all relevant data. For example, if a network of devices associated with a particular user includes multiple edge devices, the local node may aggregate data received from the other sensors in the network.

At 732, the local node determines the appropriate action to be taken, based on the result obtained at 730. The local node may apply user defined settings to the collection of data to determine an appropriate action. For example, the local interpretation module of the node may interpret the result of the global model to determine whether the event should be labelled a green or red event. For example, the local interpretation module may include a matrix that associates specific packet feature types with green or red events or with specific actions as described previously with reference to FIGS. 3-4.

If at 718, the packet feature is not recognized by the global model, for example, the threshold limit function returns no results, the method 600 proceeds to 734, corresponding to a yellow event.

The yellow event may be recorded in the event log at 722. The record associated with the event can include information including, but not limited to, a specific node ID, a packet feature identifier, a time of day, or a placeholder for an action taken or requested.

At 736, the local model of the node is trained. The local node may add the unrecognized packet feature to its local repository of packet feature types. For example, the local node may store the image captured in a local directory. In some cases, for example, the local node may maintain a directory of previously accepted packet feature types organized in folders and store the packet feature captured in a new folder. Subsequent packet features associated with this packet feature type may be stored in the same folder. The directory may be stored on the network device or may be stored on an external storage device accessible to the network device, for example a network attached storage (NAS). In cases where multiple network devices are associated with one user, it may be advantageous to store the packets on an NAS. In at least one embodiment, data that contains no identifiable information may also be stored in a repository accessible by all nodes in the system.

The node may train the local model using a multi-class classification using standard back propagation on feed forward networks by implementing stochastic gradient descent over some amount of epochs until testing accuracy reaches some acceptable error rate.

At 738, when the local node has trained the local model, the trained local model is placed into a blockchain block and transmitted to all participating mining nodes N_{YM}.

At 740, when the mining nodes N_{YM} receive the block submitted by the local node, each of the mining nodes performs anomaly detection to verify that the block does not contain a model that is detrimental to the effectiveness of the global model. For example, the mining nodes may precompute the new global model that would be generated if the local node block is appended to the blockchain and compute the error rate associated with the packet feature type in the node's own directory using the new global model with the error associated with the current global model. If the difference in error rate is within a predetermined acceptable threshold, the mining node may indicate that the new block is acceptable. If the mining mode determines that the block may contain a model that is detrimental to the effectiveness of the global model, the mining node may indicate that the model is not acceptable. The mining nodes may transmit a PoS response that includes an “accept” or a “do not accept” message, and metadata associated with the mining node. For example, a number of unique packet feature types in the directory associated with the mining node may be included in the PoS response. The number of unique packet feature types in the directory associated with the mining node may be an indication of the trustworthiness of the node.

At 742, the mining nodes determine if the block is to be appended. Responses that are submitted by mining nodes within an acceptable amount of time, for example, a predetermined amount of time, are aggregated by the mining nodes. A response may be randomly chosen given a weighted vote based on the number of accepted/not accepted responses. For example, all responses received before a cut-off time may be summed, and a chance of acceptance may be calculated based on the number of nodes that accepted the new block and the total number of responses received. A random number may then be generated, such as between 0 and 1 inclusively, and if the random number is smaller than or equal to the acceptance rate, the block may be accepted.

If the block is accepted, the method 700 proceeds to 744 and the block is appended to the blockchain. If the block is not accepted, the method 700 proceeds to 746. If the block is accepted, the local node proceeds to 730 described above, and all other nodes proceed to 748. At 744, the mining nodes append the block to the blockchain and notify all other nodes in the network of the change. At 748, all nodes in the network other than the node responsible for the system event receive the new block.

By appending this new block, the global model is updated. The new global model may be expressed as a weighted sum of models using the following equation:

M_{G}=ΣΦ(M_{X})

where Φ(M_{X})=α×M_{L}, where α is a fraction representative of the trustworthiness of the node and M_{L} is the local model. The measure of trustworthiness may be based on the number of unique persons in the repository associated with the node or may be based on the number of times a person from the node is identified when compared to other nodes.

At 750 each of the nodes in the network may replace the previous model associated with the local node in memory with the new model.

At 752, each node then runs a model aggregation function to update the global model.

If the block is not accepted, the method proceeds to 754. At 754, the local node N_{LC} receives a message that the block was rejected by the miners.

At 756, data associated with the yellow event is discarded. Discarding information relating to an event that will lead to an anomalous result and that is detrimental to the effectiveness of the global model may save resources, as only information that is useful is retained in the global model.

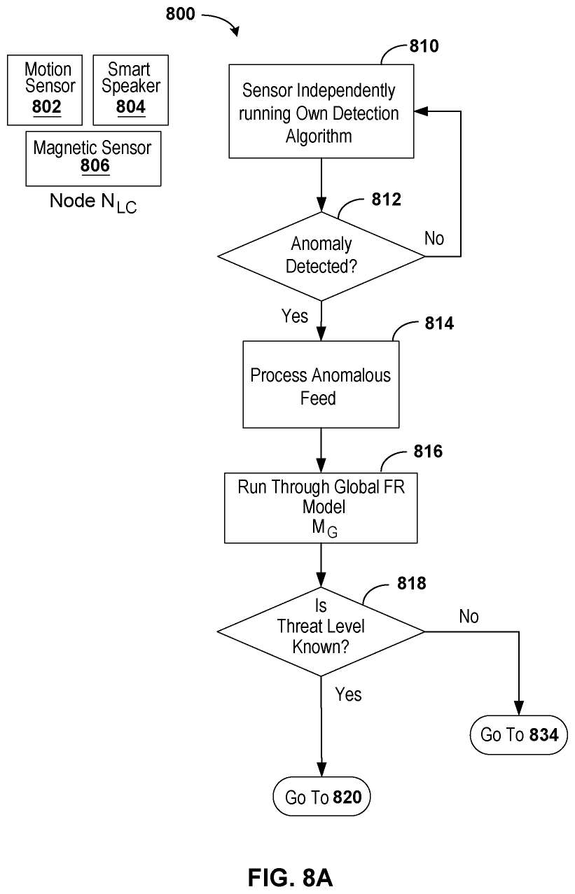

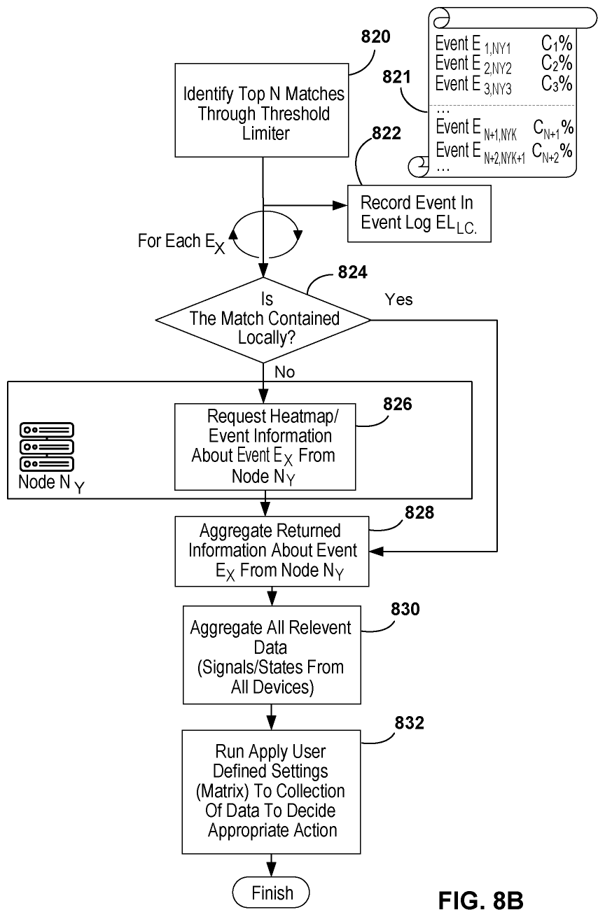

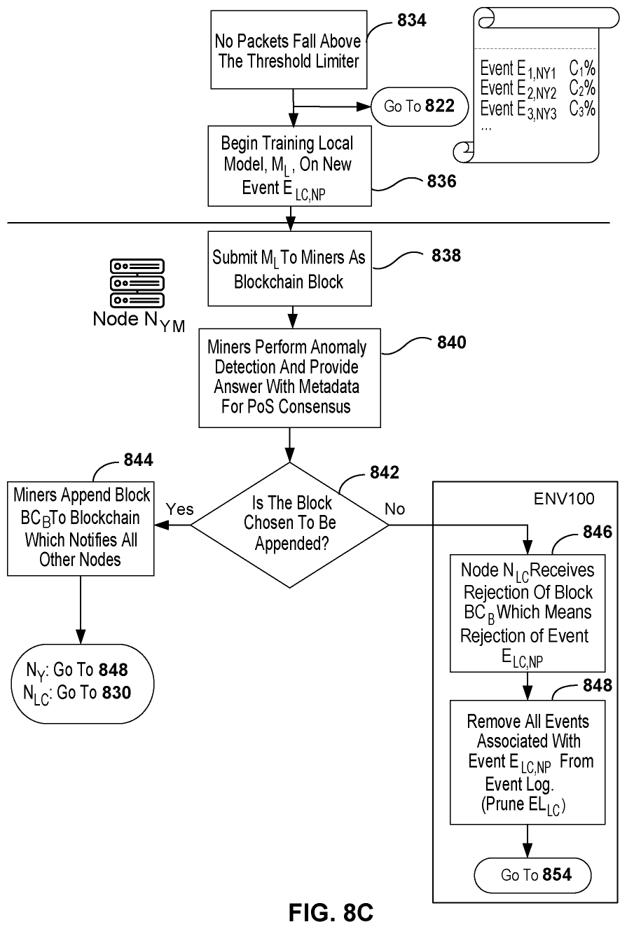

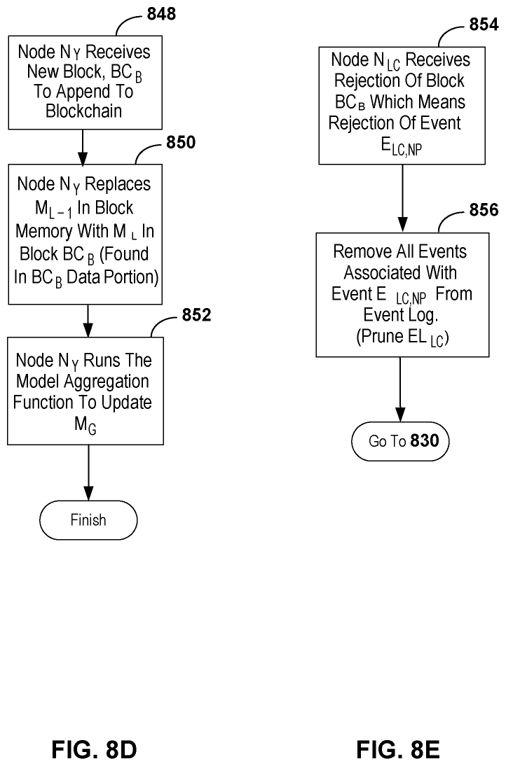

Referring now to FIGS. 8A-8E, shown therein are flowcharts of an example method 800 of processing a security threat using IoT sensors in accordance with the system of FIGS. 1-3. In this example embodiment, the local node N_{LC} includes a motion sensor 802, a smart speaker (microphone) 804, and a magnetic sensor 806 such as, but not limited to, a window sensor or a door sensor. The sensors can be associated with a user of the security threat detection and reaction system and can form part of a home security system. It will be appreciated that the motion sensor 802, the smart speaker (microphone) 804, and the magnetic sensor 806 are shown for illustrative purposes, and any other type of IoT sensor may be used. It will also be appreciated that any number IoT sensors may be used. For example, the node N_{LC} may include additional IoT sensors or fewer sensors. The number may depend on the type of sensors. For example, a single window sensor may be used for skyline-type windows or for windows that can only be opened under specific conditions (e.g., commercial building windows). Each of the sensors may provide a continuous detection feed to continuously detect anomalies. For example, the motion sensor 802 may continuously detect changes in the motion sensor's environment, for example, in the optical, microwave, or acoustic field of the motion sensor. The smart speaker (microphone) 804 may continuously perform sound detection. The magnetic sensor 806 may continuously monitor the magnetic force between the components of the magnetic sensor 806.

At 810 and 812, the sensors independently perform anomaly detection, according to each sensor's specifications until an anomaly is detected. For example, in the case of the motion sensor 802, an anomaly may be detected when movement is detected in the vicinity of the sensor. In the case of the magnetic sensor 806, an anomaly may be detected when the magnet is separated from the sensor, corresponding to the window or door on which the magnetic sensor 806 is attached being opened. In the case of the smart speaker (microphone) 804, an anomaly may be detected when a loud noise is recorded, when a voice is detected, or when an unusual sound pattern is detected. When an anomaly is detected, the portion of the sensor feed that includes the anomaly may be isolated. For example, the sound clip recorded by the smart speaker (microphone) 804 may be isolated.

In at least one embodiment, the sensors may perform anomaly detection until an anomaly is detected. In some cases, the sensor may perform anomaly detection until an anomaly is detected by at least two sensors, for example, until at least two of the motion sensors 802, the smart speaker (microphone) 804, and the magnetic sensor 806 detect an anomaly. The number of sensors detecting an anomaly required to trigger security threat detection and reaction may vary depending on the type of sensors used and the location of the sensors. For example, the detection of an anomaly by two sensors in close proximity may trigger a security threat detection and reaction sequence, while the detection of an anomaly by two sensors located at a distance may not trigger security threat detection and reaction. The detection of an anomaly by at least two sensors can reduce the detection of events that do not pose a security threat. For example, movement in the vicinity of a motion sensor 802 placed on the front door of a house may not be recorded as an anomaly by the system if no anomaly is detected by the smart speaker (microphone) 804 and the magnetic sensor 806, as it may correspond to an innocuous event, for example, a mail carrier delivering mail or a small animal passing by the motion sensor 802. As described above, in some cases, a single sensor detecting an anomaly may be sufficient for the sensor event to be analyzed, for example, a single window sensor on a skyline window may be sufficient to detect a breach of security. Alternatively, an anomaly may be recorded only if a specific pattern is detected by one or more sensors. For example, the motion sensor 802 may be capable of detecting the presence of a human as opposed to an animal or meteorological events and may detect an anomaly when a human is detected in the vicinity of the motion sensor 802. In at least one embodiment, an anomaly may be recorded each time a sensor detects a change in its environment and the determination of whether the anomaly corresponds to a real-world anomaly is determined by the global model. For example, the smart speaker (microphone) 804 can record an anomaly every time sound is detected and the global model can process the sound clip to determine whether the sound clip corresponds to a real-world anomalous event.

At 804, the anomalous feed may be preprocessed. The feed of each sensor may be processed by a processor on the sensor. Alternatively, the anomalous feeds may be transmitted to an external processor for processing, for example, to combine the feeds from various sensors. Preprocessing functions can include normalizing the data from each sensor such that the processed data is of a format or type that is compatible with the global model and combining data.

At 816, the anomaly feed or the preprocessed anomaly feed is run through the global model. As described above with reference to FIG. 3, the local node may be configured to run the global model.

At 818, the global model determines if the threat level of the anomaly feed is known or unknown. A known threat level is a threat level that can be identified by the system, such as the threat level associated with a known event. If the global model can determine the threat level, the method proceeds to 820. If the model does not recognize the threat, the method proceeds to 834 and the event is categorized as a yellow event. Alternatively, the global model determines if the pattern in the anomalous feed is known or unknown, corresponding to a known or unknown IoT event. A known IoT event or anomaly pattern is an event or pattern that can be identified by the system, such as an event or a pattern that has been previously encountered by the system.

The global model may return a list of all IoT events known by the model and an associated confidence level that the anomaly feed fed into the global model corresponds to a particular event. Each row in the list may include an identifier given to an anomalous event at the end of the first event associated with the anomalous event and a confidence score that the anomaly feed fed through the global model is associated with the event associated with the identifier as shown in box 821. For example, for a given row N, a unique event K first detected at node N_{y}, where N_{y} is any node in the network other than the current node which captured the anomalous feed, a label E_{N, NYK} may be assigned to this event. Alternatively, each row may include an identifier given to an IoT event by a node, a node identifier, and a confidence score that the IoT event run through the global model corresponds to the event associated with the identifier. In such cases, there may be more than one row associated with the event. For example, the motion sensor 802, the smart speaker (microphone) 804, and the magnetic sensor 806 detecting a specific anomaly pattern may correspond to a break-in, having a specific threat level. Alternatively, the detection of an anomaly by the motion sensor 802, the smart speaker (microphone) 804, and the magnetic sensor 806 may be associated with a specific threat level without being associated with a particular event. For example, the specific combination of a particular group of sensors detecting an anomaly may be associated with a threat level.

At 820, the local node identifies the top matches. To identify the threat level, a threshold limiter function may be used. The threshold limiter function may, for example, select the row in the list associated with the highest confidence, select the row with the highest confidence out of all the rows associated with a percentage confidence higher than predetermined threshold, for example 90%, or choose all rows associated with confidence levels above a predetermined threshold, for example 95%.

At 822, the event may be recorded in an event log. The record associated with the event can include information including, but not limited to, a specific node ID, an event identifier, a time of day, the sensors which detected the anomaly, or an action taken or requested due to the event.

At 824, the local node determines if the match is contained locally. If the match is contained locally, the method optionally proceeds to 828 and otherwise proceeds to 830. The match may be contained locally if the threat level or the event identified using the global model has previously occurred at node N_{LC} is accordingly included in the local model of the node. For each match or for the top match, depending on the threshold limiter function used, the node may determine if the match is contained locally.

If the match is not contained locally, the method proceeds to 826. At 826, the node may request event information about each of the threat level or events identified at 820 from the nodes that have previously encountered the event or threat level. For example, the system may identify the node that has the highest level of confidence that the event detected in the anomaly feed was a given event Ex and identify each instance of the event being identified.

At 828, the local node may aggregate information about the event identified from all nodes which have previously encountered event Ex. For example, the system may gather event logs associated with the event identified from participating nodes in the network. The event logs may be aggregated and/or summarized and used at 832 to determine an action to be taken.

At 830, the local node aggregates all relevant data. For example, in cases where the data from each IoT sensor is processed by a different global model, the local node may aggregate data received from other sensors.

At 832, the local node determines the appropriate action to be taken, based on the result obtained at 830. The local node may apply user defined settings to the collection of data to determine an appropriate action. For example, the local interpretation module of the node may interpret the result of the global model to determine whether the event should be labelled a green or red event. For example, the local interpretation module may include a matrix that associates specific threat levels or specific events with green or red events or with specific actions as described previously with reference to FIGS. 3-4.

If at 818, the event or the threat level is not identified by the global model, for example, the threshold limit function returns no results, the method 800 proceeds to 834, corresponding to a yellow event.

The yellow event may be recorded in the event log at 822. The record associated with the event can include information including, but not limited to, a specific node ID, an event identifier, a time of day, the sensors which detected the anomaly, or an action taken or requested due to the event.

At 836, the local model of the node is trained. The local node may add the unrecognized event or threat level to a local repository. For example, the local node may store the anomaly feed in a local directory. In some cases, for example, the local node may maintain a directory of previously accepted events organized in folders and store the anomaly feed captured in a new folder. In other cases, the directory may contain data specific to each type of sensor. For example, the smart speaker (microphone) 804 may be associated with a repository of audio clips. Subsequent anomalous events associated with this event may be stored in the same folder. The directory may be stored on each of the sensors or may be stored on an external storage device accessible to the sensors, for example a network attached storage (NAS). In cases where multiple sensors are associated with one user, it may be advantageous to store the anomaly feeds on an NAS. In at least one embodiment, data that contains no identifiable information may also be stored in a repository accessible by all nodes in the system.

The node may train the local model using a multi-class classification using standard back propagation on feed forward networks by implementing stochastic gradient descent over some amount of epochs until testing accuracy reaches some acceptable error rate.

At 838, when the local node has trained the local model, the trained local model is placed into a blockchain block and transmitted to all participating mining nodes N_{YM}.

At 840, when the mining nodes N_{YM} receive the block submitted by the local node, each of the mining nodes performs anomaly detection to verify that the block does not contain a model that is detrimental to the effectiveness of the global model. For example, the mining nodes may precompute the new global model that would be generated if the local node block is appended to the blockchain and compute the error rate associated with the events in the node's own directory using the new global model with the error associated with the current global model. If the difference in error rate is within a predetermined acceptable threshold, the mining node may indicate that the new block is acceptable. If the mining mode determines that the block may contain a model that is detrimental to the effectiveness of the global model, the mining node may indicate that the model is not acceptable. The mining nodes may transmit a PoS response that includes an “accept” or a “do not accept” message, and metadata associated with the mining node. For example, a number of unique events in the directory associated with the mining node may be included in the PoS response. The number of unique events in the directory associated with the mining node may be an indication of the trustworthiness of the node.

At 842, the mining nodes determine if the block is to be appended. Responses that are submitted by mining nodes within an acceptable amount of time, for example, a predetermined amount of time, are aggregated by the mining nodes. A response may be randomly chosen given a weighted vote based on the number of accepted/not accepted responses. For example, all responses received before a cut-off time may be summed, and a chance of acceptance may be calculated based on the number of nodes that accepted the new block and the total number of responses received. A random number may then be generated, between 0 and 1 inclusively, and if the random number is smaller than or equal to the acceptance rate, the block may be accepted.

If the block is accepted, the method 800 proceeds to 844 and the block is appended to the blockchain. If the block is not accepted, the method 800 proceeds to 846. If the block is accepted, the local node proceeds to 830 described above, and all other nodes proceed to 848. At 844, the mining nodes append the block to the blockchain and notify all other nodes in the network of the change. At 848, all nodes in the network other than the node responsible for the system event receive the new block.

By appending this new block, the global model is updated. The new global model may be expressed as a weighted sum of models using the following equation:

M_{G}=ΣΦ(M_{X})

where Φ(M_{X})=α×M_{L}, where α is a fraction representative of the trustworthiness of the node and M_{L} is the local model. The measure of trustworthiness may be based on the number of unique IoT events in the repository associated with the node or may be based on the number of times an IoT event from the node is identified when compared to other nodes.

At 850, each of the nodes in the network may replace the previous model associated with the local node in memory with the new model.

At 852, each node then runs a model aggregation function to update the global model.

If the block is not accepted, the method proceeds to 854. At 854, the local node N_{LC} receives a message that the block was rejected by the miners. At 856, data associated with the yellow event is discarded. Discarding information relating to an event that will lead to an anomalous result and that is detrimental to the effectiveness of the global model may save resources, as only information that is useful is retained in the global model.

In at least one embodiment, the system as described in FIGS. 1-3 is configured to operate with multiple types of devices where there may be interaction between the models of these devices. For example, each device or each sensor of a device may be associated with a global model and the output of the global model associated with each device or sensor may be combined. Alternatively, data from multiple types of devices may be input into a global model configured to receive data from different types of devices. In some cases, data from multiple types of devices may be preprocessed and converted into a format accepted by a global model, before being inputted into the global model.

As will readily be understood by the skilled reader, various elements of the embodiments of FIGS. 6A, 7A and 8A may be combined into a single system. For example, a system could include video camera 602, networking device 702 and/or any one or more of motion sensor 802, smart speaker (microphone) 804, and magnetic sensor 806. Other configurations would also be understood by the skilled reader to be within the scope of the present disclosure.

One technical advantage realized in at least one of the embodiments described herein is increased speed and decrease in lag time, relative to centralized federated learning systems. Centralized federated learning systems may suffer from bottleneck issues, as a single central server is used to coordinate all participating nodes in the network and all participating nodes must send updates to the single central server if data is to be sent.

Another significant technical advantage realized in at least one of the embodiments described herein relates to avoiding the need to centrally collect and process confidential information in order to provide users with personalized threat detection and response capabilities. By providing a federated learning threat detection system, it is possible for all similar nodes in the system to use the same global model to arrive at anonymized results. By combining this system with a local interpretation layer however, it is possible for each local node in a system to interpret the anonymized results into highly personalized results, which can then be used to trigger highly personalized actions. Thus, by providing a multi-layered federated learning threat detection and response system, it is possible to optimize for both enhanced privacy and customization.

Another technical advantage realized in at least one of the embodiments described herein is a decrease in computational time and resource utilization. The use of mining nodes can allow anomaly detection to be performed by a select number of nodes, rather than all nodes in the system, which may, in some cases, have limited computational resources, decreasing computational time and resource utilization.

Another technical advantage realized in at least one of the embodiments described herein is a reduction in memory requirements by way of using the blockchain pointers described herein. A dynamic reduction in the size of the blockchain as models are appended to the blockchain allows the size of the blockchain to be constrained.

Another technical advantage realized in at least one of the embodiments described herein is an increase in computational speed. By storing pointers within each block, pointing to the last version of the block, the entire blockchain does not need be traversed. The blockchain can be read from the end of the blockchain, a block associated with a local model containing a pointer to the previous version of the local model may be read, and the previous version may be accessed and, in some cases, discarded.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A device of a plurality of devices in a decentralized federated learning security system, the device comprising:
one or more local AI models each configured to receive inputs from the one or more sensors and to be trained to make a prediction relating to events of an event type being sensed by the one or more sensors;
one or more associated global AI models each configured to receive inputs from the one or more sensors and to make a prediction relating to events of an event type being sensed by the one or more sensors, wherein each of the one or more global AI models relating to a given event type is comprised of an aggregation of local AI models from the plurality of devices relating to the given event type; and
one or more processors configured to:
train a local AI model relating to an associated global AI model using new inputs received from the one or more sensors when inputting the new input into the associated global AI model fails to result in a prediction having threshold characteristics, thereby creating a newly trained local AI model, and
send the newly trained local AI model to other devices of the plurality of devices; and
a memory containing newly trained local AI models of the plurality of devices.

2. The device of claim 1, wherein the one or more processors are further configured to:
receive a newly trained local AI model associated with a particular event type from another device of the plurality of devices; and
validate the received newly trained local AI model by:
selecting a plurality of the most recent local AI models associated with the particular event type from the memory,
aggregating the selected local AI models and the received newly trained AI model into an aggregated AI model,
detecting anomalies in the aggregated AI model, and
sending a validation signal associated to the newly trained AI model to a set of devices of the plurality of devices if no anomaly is detected.

3. The device of claim 2, wherein the one or more processors are further configured to:
upon receipt of a validation signal from a device of the plurality of devices,
store a newly trained model associated with the validation signal to the memory,
select a plurality of the most recent local AI models associated with the particular event type from the memory, and
aggregate the selected local AI models and the received newly trained AI model into a new global AI model.

4. The device of claim 2, wherein the step of aggregating the selected local AI models includes summing the local AI models.

5. The device of claim 2, wherein validation of the newly trained model is further performed using a consensus mechanism.

6. The device of claim 5, wherein the consensus mechanism is a proof-of-stake consensus mechanism.

7. The device of claim 1, further comprising a local interpretation module configured to interpret predictions made by the global machine learning model using local information relevant to the user of the edge device in order to produce a threat assessment.

8. The device of claim 7, wherein the threat assessment comprises a determination of one of three or more threat levels.

9. The device of claim 8, wherein the determination of the one of three or more threat levels is based at least in part on the threshold characteristics.

10. The device of claim 7, wherein the threat assessment is used to perform an action by the system.

11. The device of claim 1, wherein the action is one of: notifying a user and/or owner of the system, notifying the police, doing nothing, and sounding an alarm.

12. (canceled)

13. The device of claim 1, wherein the threshold characteristics include a confidence level related to the prediction.

14. The device of claim 1, wherein the one or more sensors includes a video camera, and the event type is associated with the detection of an optical or auditory characteristic of the video feed.

15. (canceled)

16. The device of claim 1, wherein the one or more sensors includes a packet analyzer, and the event type is associated with packet features, wherein the packet features include one or more of packet source address, packet destination addresses, type of service, total length, protocol, checksum, and data/payload.

17. (canceled)

18. The device of claim 1, wherein the one or more sensors is an Internet of Things (IoT) sensor, and the event type is associated with signals received from the IoT sensor.

19. The device of claim 1, wherein the memory comprises a blockchain containing newly trained local AI models of the plurality of devices.

20. The device of claim 19, wherein each block in the blockchain comprising a newly trained local machine learning model of a given device contains a pointer to the immediately preceding version of the newly trained machine learning model of the given device.

21. A method of operating a device of a plurality of devices in a decentralized federated learning security system, wherein each device comprises one or more local AI models each configured to receive inputs from the one or more sensors and to be trained to make a prediction relating to events of an event type being sensed by the one or more sensors, and one or more associated global AI models each configured to receive inputs from the one or more sensors and to make a prediction relating to events of an event type being sensed by the one or more sensors, wherein each of the one or more global AI models relating to a given event type is comprised of an aggregation of local AI models from the plurality of devices relating to the given event type, and a memory containing newly trained local AI models of the plurality of devices, the method comprising:
training a local AI model relating to an associated global AI model using new inputs received from the one or more sensors when inputting the new input into the associated global AI model fails to result in a prediction having threshold characteristics, thereby creating a newly trained local AI model; and
sending the newly trained local AI model to other devices of the plurality of devices.

22. The method of claim 21, further comprising:
receiving a newly trained local AI model associated with a particular event type from another device of the plurality of devices; and
validating the received newly trained local AI model by:
selecting a plurality of the most recent local AI models associated with the particular event type from the memory,
aggregating the selected local AI models and the received newly trained AI model into an aggregated AI model,
detecting anomalies in the aggregated AI model, and
sending a validation signal associated to the newly trained AI model to a set of devices of the plurality of devices if no anomaly is detected.

23. The method of claim 22 further comprising, upon receipt of a validation signal from a device of the plurality of devices:
storing a newly trained model associated with the validation signal on the memory,
selecting a plurality of the most recent local AI models associated with the particular event type from the memory, and
aggregating the selected local AI models and the received newly trained AI model into a new global AI model.

24. The method of claim 22, wherein aggregating the selected local AI models includes summing the local AI models.

25. The method of claim 22, wherein validation of the newly trained model is further performed using a consensus mechanism.

26. The method of claim 25, wherein the consensus mechanism is a proof-of-stake consensus mechanism.

27. The method of claim 21, further comprising:
interpreting predictions made by the global machine learning model using local information relevant to the user of the edge device in order to produce a threat assessment.

28-39. (canceled)

40. A decentralized federated learning security system comprising a plurality of devices in accordance with claim 1.

41. A decentralized federated learning security system comprising a plurality of devices configured to perform a method in accordance with claim 21.
